(19) United States
(12) Patent Application Publication
(10) Pub. No.: US 2025/0214873 A1
(43) Pub. Date: Jul. 3, 2025

(54) METHOD FOR REMOVING CARBON DIOXIDE

(71) Applicant: CARBON BLUE LTD., Haifa (IL)

(72) Inventors: Dan DEVIRI, Tel Aviv Yafo (IL); Iddo Mehnashe TSUR, Atlit (IL); Uri KELLY, Kohav Ya’ir (IL)

(73) Assignee: CARBON BLUE LTD., Haifa (IL)

(21) Appl. No.: 18/849,673

(22) PCT Filed: Mar. 27, 2023
(86) PCT No.: PCT/IL2023/050316

§ 371 Date: Sep. 23, 2024

Related U.S. Application Data
(60) Provisional application No. 63/324,157, filed on Mar. 28, 2022.

(51) Int. Cl. C02F 1/52; C01F 11/18; C02F 1/66; C02F 101/10; C02F 103/08

(52) U.S. Cl. CPC C02F 1/5245; C01F 11/18; C02F 1/66; C01P 2004/61; C02F 2101/10; C02F 2103/08

(57) ABSTRACT

The present disclosure generally relates to field of carbon dioxide isolation and capture.

### TECHNICAL FIELD

The present disclosure generally relates to field of carbon dioxide removal and capture.

### BACKGROUND

Climate change is caused by anthropogenic emissions of greenhouse gases to the atmosphere, with carbon dioxide (CO₂) being the most prominent contributor to the greenhouse effect. Global initiatives are currently promoting decarbonization (reduction of CO₂ emissions resulting from human activity to the atmosphere) of entire economies and are aimed at completely ceasing CO₂ emissions by 2050. However, some human activities are still very difficult to decarbonize, which will necessitate efficient carbon dioxide removal (CDR) and Carbon capture and storage (CCS) technologies to offset residual CO₂ that continues to be emitted. Moreover, atmospheric CO₂ is stable, which results in its accumulation in the atmosphere over time. Therefore, CDR and CCS will be required to remove the excess CO₂ that will be emitted as well as the CO₂ that will accumulate in the atmosphere by the time the net-zero emissions goal is reached. Estimates by climate scientists indicate that CDR at a scale of ten billion tons of CO₂ per year will be needed by 2050 [National Research Council. 2015. Climate Intervention: Carbon Dioxide Removal and Reliable Sequestration. Washington, DC: The National Academies Press. https://doi.org/10.17226/18805.].

The majority of CDR technologies that are currently being developed are based on direct air capture (DAC), namely separating CO₂ from the atmosphere and concentrating it to a stream of nearly-pure CO₂ that is sequestered or used as a feedstock in downstream industrial processes.

US 2019/0344217 escribes systems, apparatus, and methods for gas-liquid contacting for the recovery of carbon dioxide from gases.

However, the fraction of CO₂ in the atmosphere, 0.04%, is very small. This results in a technical hurdle in the way for a scalable DAC-based CDR technology: The low concentration of atmospheric CO₂ necessitates large contact area of the CDR apparatus with the air to capture significant quantities of CO₂ from the air. For example, the CDR plant of Carbon Engineering, a leading company in the area of DAC technology, requires an area of 0.4 square kilometer for the capture of million ton of CO₂ per year from the air [Keith et al., Joule 2, 1573-1594 Aug. 15, 2018], which is only 0.01% of the required scale of CDR.

There is a need for improved methods for capturing the emitted carbon dioxide, preferably, which minimize the handling of air, which both requires specialized air treatment apparatuses and has very small CO₂ concentration, as detailed above.

### SUMMARY OF THE INVENTION

The present invention provides improved systems and methods intended to efficiently capture CO₂ present in the environment. Specifically, the present invention is directed to removing carbon dioxide dissolved in large water sources, such as oceans and seas. Thus, the present method and system for removing carbon dioxide avoid air treatment, where CO₂ is relatively scarce and may take advantage of the natural occurrence of these large water sources, where CO₂ is dissolved in higher amounts per volume, according to some embodiments.

The disclosed method removes CO₂ dissolved in bodies of water, in which the CO₂ concentration is orders of magnitude greater than in air. As a result, facilities implementing the method of the present invention can be significantly smaller in area and cheaper to construct than direct air capture-based facilities that remove CO₂ from the air at an equivalent rate. Furthermore, the disclosed method does not require any input materials except seawater and energy source, and does not generate any harmful by-products, so that facilities that implement the present method do not require complex logistics of input and output materials and can be constructed in diverse locations. Moreover, compared to other ocean-based CO₂ removal methods, the present method does not use any membranes for gas separation and electrodes, and preserves the alkalinity of the treated water and thus the decarbonated water may be returned to the water source, with an ability to re-absorb the removed CO₂ from the air with no negative environmental consequences on marine life and ocean chemistry. Yet another environmental advantage of the present process is the positive effect on the aquatic ecosystem and life within the oceans and seas. Specifically, a recent climate change report by the Intergovernmental Panel on Climate Change (IPCC) predicted that the amount of CO₂ in the ocean may increase to 851-1370 ppm by 2100, and to 1371-2900 ppm by 2150 (IPCC 2014, Synthesis report in climate change 2014: contribution of working groups I, II and III to the fifth assessment report of the Intergovernmental Panel on Climate Change. Geneva, Switzerland: IPCC). This has an adverse effect on marine life (Oh et al. (2017) Effect of increased CO₂ in seawater on survival rate of different developmental stages of the harpacticoid copepod Tigriopus japonicus, Animal Cells and Systems, 21:3, 217-222).

According to some embodiments, to achieve this goal the present method involves reacting CO₂ species present in carbonated water from a large water reservoir as described herein, with carbon dioxide scavenger, such as Ca(OH)₂. Upon the reaction taking place, according to some embodiments, a solid water-insoluble scavenged carbon species and decarbonated water are formed. When using a calcium base as carbon dioxide scavenger, it results in the formation of CaCO₃, which is water insoluble and simple to separate from the decarbonated water, according to some embodiments. Then, according to some embodiments, the decarbonated water may be returned to the water source. Advantageously, the present method is conducted such that the alkalinity of the decarbonated water formed thereby is substantially equal to the alkalinity of the original water in the reservoir. This allows the recycling of the decarbonated water formed through the present method, back to the water reservoir to have a positive environmental effect. The scavenged carbon species may then be dissociated into CO₂ gas and a solid salt. According to some embodiments, as the formed carbon dioxide is a gas, it is again simple to separate and capture, thereby achieving the carbon dioxide removal goal. When the scavenged carbon species is CaCO₃, the solid salt formed upon its dissociation is CaO, which then preferably be slaked into Ca(OH)₂ to complete a recycling cycle of the reagents used in the removal method, according to some embodiments. Thus, the method of the present invention is environmentally friendly, cost effective and minimizes the produced waste through recycling.

Furthermore, according to some embodiments, the present invention provides an interconnected 3-module system, which is configured to effectively carry out the carbon dioxide removal method. According to some embodiments, the present system includes (a) a pellet reactor, which receives the carbonated water from the water source (e.g., it is configured to draw water from the ocean via a pump) and the carbon dioxide scavenger, so that the reaction forming the scavenged carbon species is taking place in the pellet reactor; (b) a calciner which is configured to receive the scavenged carbon species from the pellet reactor and dissociate it into CO₂ and the solid salt; and (c) a steam slaker, which is arranged to receive the solid salt from the calciner and to receive or create steam, to regenerate the carbon dioxide scavenger, and to transfer the regenerated carbon dioxide scavenger into the pellet reactor.

The present system may be conveniently positioned on land or sea. The system may be land-based coastal system positioned close to a source of sea water. Also, it may be positioned in an interior location, where water is piped into the system from a carbonated water source, e.g., ocean. Alternatively, the system may be a water-based system, i.e., a system that is present on or in water. Such a system may be present on a boat, an ocean-based platform etc., as desired. Moreover, the system may be positioned in the vicinity of a natural gas off-shore drilling rig.

The following embodiments and aspects thereof are described and illustrated in conjunction with systems, tools and methods, which are meant to be exemplary and illustrative, not limiting in scope.

According to some embodiments, there is provided a method for removing carbon dioxide (CO₂), the method comprising the step of:
(I) providing carbonated water from a natural or unnatural carbonated water source, wherein the carbonated water comprises an inorganic carbonated species selected from the group consisting of: CO₂, H₂CO₃, HCO₃⁻ and a combination thereof, at a first concentration;
(II) providing a carbon dioxide scavenger;
(III) contacting the carbonated water with the carbon dioxide scavenger to form a solid water-insoluble scavenged carbon species and decarbonated water;
(IV) isolating the scavenged carbon species from the decarbonated water, wherein the decarbonated water has final alkalinity, which is in the range of 75% to 125% of the initial alkalinity;
(V) transferring the decarbonated water to the natural or unnatural carbonated water source;
(VI) dissociating the scavenged carbon species to form carbon dioxide and a decarbonated solid material; and
(VII) capturing the carbon dioxide formed in step (VI).

According to some embodiments, the carbonated water source is a natural carbonated water source.

According to some embodiments, the natural carbonated water source is selected from the group consisting of: an ocean, a sea, a river, a lake and an inland water body.

According to some embodiments, the carbonated water source has an area of at least 100 km².

According to some embodiments, the natural or unnatural carbonated water source has substantially the same chemical composition of the carbonated water provided in step (I).

According to some embodiments, the carbonated water comprises HCO₃. According to some embodiments, the carbonated water further comprises CO₃⁻². According to some embodiments, the carbonated water comprises HCO₃⁻ and CO₃⁻².

According to some embodiments, the carbonated water comprises at least 2 HCO₃⁻ ions per one CO₃⁻² ion. According to some embodiments, the carbonated water comprises 3 to 3000 HCO₃⁻ ions per one CO₃⁻² ion. According to some embodiments, the carbonated water comprises at least 1000 HCO₃⁻ ions per one CO₃⁻² ion.

According to some embodiments, the first concentration is at least 1 mM.

According to some embodiments, the carbonated water of step (I) has pH in the range of 6 to 10. According to some embodiments, the carbonated water of step (I) has pH in the range of 7 to 8.5. According to some embodiments, the carbonated water of step (I) has pH in the range of 10 to 11.

According to some embodiments, the salinity of the carbonated water of step (I) is in the range of 0.5 to 100 g/L.

According to some embodiments, the carbonated water of step (I) has a concentration of CO₃⁻² of no more than 10 mM.

According to some embodiments, step (I) comprises drawing the carbonated water from the carbonated water source using a water pump.

According to some embodiments, the carbon dioxide scavenger is an inorganic base.

According to some embodiments, the carbon dioxide scavenger is Ca⁺² salt.

According to some embodiments, the carbon dioxide scavenger is Ca(OH)₂.

According to some embodiments, the Ca(OH)₂: total inorganic carbonated species in the carbonated water ratio is in the range of 4:10 to 12:10 mol/mol.

According to some embodiments, the carbonated water comprises HCO₃⁻, and wherein the contacting of carbonated water with the Ca(OH)₂ in step (III) entails carrying out the chemical reaction:

HCO₃⁻+Ca(OH)₂→CaCO₃+H₂O+OH;
thereby producing CaCO₃ as the solid water-insoluble scavenged carbon species, and decarbonated water.

According to some embodiments, the contacting of carbonated water with the Ca(OH)₂ in step (III) entails carrying out one or more of the chemical reactions:

CO₂+Ca(OH)₂→CaCO₃+H₂O;

H₂CO₃+Ca(OH)₂→CaCO₃₊₂H₂O;

HCO₃⁻+Ca(OH)₂→CaCO₃+H₂O+OH⁻.
thereby producing CaCO₃ as the solid water-insoluble scavenged carbon species, and decarbonated water.

According to some embodiments, the alkalinity of the carbonated water of step (I) is 0.8 to 1.2 times the alkalinity of the decarbonated water of step (III). According to some embodiments, the alkalinity of the decarbonated water is substantially equal to the alkalinity of the carbonated water of step (I).

According to some embodiments, the contacting of carbonated water with the Ca(OH)₂ in step (III) further entails carrying out the reaction:

CO₃⁻²+Ca(OH)₂→CaCO₃+2OH⁻.

According to some embodiments, at least 50% mol/mol of the total inorganic carbonated species in the carbonated water of step (I) is HCO₃.

According to some embodiments, the carbon dioxide scavenger is Ca⁺² salt, wherein the carbonated water comprises HCO₃⁻, and wherein the contacting thereof in step (III) entails contacting 0.5 to 2.5 moles of HCO₃⁻ per 1 mol of Ca⁺².

According to some embodiments, the carbon dioxide scavenger is Ca⁺² salt, wherein the carbonated water comprises inorganic carbonated species, and wherein the contacting thereof in step (III) entails contacting 0.5 to 2.5 moles of inorganic carbonated species per 1 mol of Ca⁺².

According to some embodiments, the carbon dioxide scavenger is Ca⁺² salt, wherein the carbonated water comprises HCO₃⁻, and wherein the contacting thereof in step (III) entails contacting providing the carbon dioxide scavenger and the carbonated water continuously or in batches at a predetermined rate, so as to maintain a ratio of 0.5 to 2.5 moles of HCO₃⁻ per 1 mol of Ca⁺² in the mixture of step (III). According to some embodiments, the carbon dioxide scavenger is Ca⁺² salt, wherein the carbonated water comprises inorganic carbonated species, and wherein the contacting thereof in step (III) entails contacting providing the carbon dioxide scavenger and the carbonated water continuously or in batches at a predetermined rate, so as to maintain a ratio of 0.5 to 2.5 moles of inorganic carbonated species per 1 mol of Ca⁺² in the mixture of step (III).

According to some embodiments, forming a solid water-insoluble scavenged carbon species in step (III) comprises inducing precipitation of the water-insoluble scavenged carbon species from the water, through seeding seeds of the water-insoluble scavenged carbon species in the mixture of step (III).

According to some embodiments, the solid water-insoluble scavenged carbon species has aqueous solubility of no more than 100 mg/L at 25° C.

According to some embodiments, the solid water-insoluble scavenged carbon species is CaCO₃.

According to some embodiments, forming CaCO₃ in step (III) comprises inducing precipitation of the CaCO₃ from the water, through seeding seeds of CaCO₃ in the mixture of step (III).

According to some embodiments, the seeds of CaCO₃ have an average particle size in the range of 0.07 to 0.160 millimeters.

According to some embodiments, step (III) further comprises allowing maturation of pellets of precipitated CaCO₃, to a pellet size in the range of 0.15 to 0.5 millimeters, wherein the step (IV) comprises isolating the precipitated CaCO₃ pellets, matured to said pellet size.

According to some embodiments, the seeds of CaCO₃ have an average particle size, wherein step (III) further comprises allowing maturation of pellets of precipitated CaCO₃, to a pellet size, wherein the step (IV) comprises isolating the precipitated CaCO₃ pellets, matured to said pellet size, and wherein the particle size of the matured CaCO₃ pellets is at least 100% greater than the particle size of the seeds of CaCO₃.

According to some embodiments, the decarbonated water has inorganic carbonated species selected from the group consisting of: CO₂, H₂CO₃, HCO₃⁻ and a combination thereof, at a second concentration, wherein the first concentration is at least 1.1 times higher than the second concentration. According to some embodiments, the decarbonated water has inorganic carbonated species selected from the group consisting of: CO₂, H₂CO₃, HCO₃⁻ and a combination thereof, at a second concentration, wherein the first concentration is at least 1.3 times higher than the second concentration. According to some embodiments, the decarbonated water has inorganic carbonated species selected from the group consisting of: CO₂, H₂CO₃, HCO₃⁻ and a combination thereof, at a second concentration, wherein the first concentration is at least 2 times higher than the second concentration. According to some embodiments, the decarbonated water has inorganic carbonated species selected from the group consisting of: CO₂, H₂CO₃, HCO₃⁻ and a combination thereof, at a second concentration, wherein the first concentration is at least 3 times higher than the second concentration. According to some embodiments, the decarbonated water has inorganic carbonated species selected from the group consisting of: CO₂, H₂CO₃, HCO₃⁻ and a combination thereof, at a second concentration, wherein the first concentration is at least 4 times higher than the second concentration. According to some embodiments, the decarbonated water has inorganic carbonated species selected from the group consisting of: CO₂, H₂CO₃, HCO₃⁻ and a combination thereof, at a second concentration, wherein the first concentration is at least 5 times higher than the second concentration. According to some embodiments, the decarbonated water has inorganic carbonated species selected from the group consisting of: CO₂, H₂CO₃, HCO₃⁻ and a combination thereof, at a second concentration, wherein the first concentration is at least 10 times higher than the second concentration.

According to some embodiments, the second concentration is no more than 2 mM.

According to some embodiments, the second concentration is no more than 1.75 mM. According to some embodiments, the second concentration is no more than 1.16 mM. According to some embodiments, the second concentration is no more than 0.23 mM.

According to some embodiments, step (IV) further comprises transferring the decarbonated water to the natural carbonated water source.

According to some embodiments, dissociating the scavenged carbon species comprises heating the scavenged carbon species to induce thermal decomposition into carbon dioxide and a decarbonated solid material.

According to some embodiments, the decarbonated solid material comprises CaO.

According to some embodiments, the CO₂ formed in step (VI) is in a gas form, and step (VII) comprises isolating the CO₂ gas from the mixture of step (VI) and storing the CO₂ gas.

According to some embodiments, the method further comprises step (VIII) of processing the decarbonated solid material formed in step (VI) into a carbon dioxide scavenger and repeating steps (I)-(VI), wherein step (II) comprises providing the carbon dioxide scavenger formed in step (VIII).

According to some embodiments, the steps (I)-(IV) are devoid of air treatment.

According to some embodiments, the method is devoid of air treatment.

According to some embodiments, each one of steps (I) to (IV) is devoid of gas treatment.

According to some embodiments, the method further comprises providing a carbon removal system, wherein at least one of steps (I) to (VII) is carried out within the carbon removal system.

According to some embodiments, the carbon removal system comprises a pellet reactor, wherein step (III) comprises contacting in the pellet reactor the carbonated water with the carbon dioxide scavenger to form a solid water-insoluble scavenged carbon species and decarbonated water.

According to some embodiments, the pellet reactor is a fluidized bed reactor.

According to some embodiments, the pellet reactor comprises a first fluid inlet pipe, a fluid outlet pipe and an enclosed reaction chamber, each of the first fluid inlet pipe and the fluid outlet pipe is in fluid communication with the reaction chamber, wherein step (III) comprises inserting the carbonated water into the reaction chamber through the first fluid inlet pipe, and wherein the contacting of the carbonated water with the carbon dioxide scavenger in step (III) is carried out within the reaction chamber.

According to some embodiments, the pellet reactor further comprises a second fluid inlet pipe, wherein the second fluid inlet pipe is in fluid communication with the reaction chamber, wherein step (III) comprises inserting the carbon dioxide scavenger into the reaction chamber through the second fluid inlet pipe. According to some embodiments, step (III) comprises inserting a composition of the carbon dioxide scavenger into the reaction chamber through the second fluid inlet pipe. According to some embodiments, the composition is a solution, a slurry, a dispersion or an emulsion. Each possibility represents a separate embodiment of the invention. According to some embodiments, the composition is an aqueous composition.

According to some embodiments, step (III) comprises dissolving the carbon dioxide scavenger in the carbonated water and inserting the formed solution into the reaction chamber through the first fluid inlet pipe.

According to some embodiments, step (III) further comprises evacuating the decarbonated water through the fluid outlet pipe.

According to some embodiments, the pellet reactor further comprises a semi-permeable filter, which is permeable to water and impermeable to solids above a predetermined diameter, and is positioned to separate between the reaction chamber and the fluid outlet pipe; wherein the evacuation of the decarbonated water of step (III) comprises filtering the decarbonated water from the scavenged carbon species by flowing the decarbonated water through the semi-permeable filter, and flowing the filtered decarbonated water through the fluid outlet pipe.

According to some embodiments, the semi-permeable filter has a cutoff is in the range of 0.07 to 0.16 millimeters, including each value and sub-range within the specified range.

According to some embodiments, the enclosed reaction chamber comprises a top end and a bottom end, wherein fluid outlet pipe is connected to the reaction chamber in the vicinity of its top end, and the first fluid inlet pipe is connected to the reaction chamber in the vicinity of its bottom end. According to some embodiments, the second fluid inlet pipe is connected to the reaction chamber in the vicinity of its bottom end.

According to some embodiments, the pellet reactor further comprises a solid outlet pipe, wherein step (IV) comprises evacuating the scavenged carbon species through the solid outlet pipe, thereby isolating the scavenged carbon species from the decarbonated water.

According to some embodiments, the enclosed reaction chamber comprises a top end and a bottom end, wherein the solid outlet pipe is connected to the reaction chamber in the vicinity of its bottom end.

According to some embodiments, the pellet reactor further comprises a solid inlet pipe, wherein step (III) further comprises inserting seeds of the scavenged carbon species into the reaction chamber through the solid inlet pipe.

According to some embodiments, step (III) further comprises fluidizing the seeds in the reaction chamber.

According to some embodiments, the enclosed reaction chamber comprises a top end and a bottom end, wherein the solid inlet pipe is connected to the reaction chamber in the vicinity of its top end.

According to some embodiments, the fluidized bed pellet reactor comprises: a first fluid inlet pipe, a second fluid inlet pipe, a solid inlet pipe, a fluid outlet pipe, a solid outlet pipe and an enclosed reaction chamber, which comprises a top end and a bottom end, wherein each of the solid inlet pipe and the fluid outlet pipe is connected to the reaction chamber in the vicinity of its top end, and each of the solid outlet pipe, the first fluid inlet pipe and the second fluid inlet pipe is connected to the reaction chamber in the vicinity of its bottom end; wherein
the carbonated water comprises HCO₃″, and the carbon dioxide scavenger comprises Ca(OH)₂;
step (III) comprises:
inserting the carbonated water into the reaction chamber through the first fluid inlet pipe;
hydrating the Ca(OH)₂ in water to form an aqueous Ca(OH)₂ composition, and inserting the formed composition into the reaction chamber through the second fluid inlet pipe;
inserting CaCO₃ seeds into the reaction chamber through the solid inlet pipe in the vicinity of the reaction chamber top end and fluidizing said seeds, thereby inducing precipitation of CaCO₃ formed from a chemical reaction between the HCO₃⁻ and the Ca(OH)₂, so that the formed CaCO₃ is sinking to the bottom end of the reaction chamber and the decarbonated water flows in the direction of the top end of the reaction chamber; and
evacuating the decarbonated water from the top end of the reaction chamber through the fluid outlet pipe; and
step (IV) comprises evacuating the CaCO₃ from the bottom end of the reaction chamber through the solid outlet pipe.

According to some embodiments, the fluidized bed pellet reactor comprises: a first fluid inlet pipe, a solid inlet pipe, a fluid outlet pipe, a solid outlet pipe and an enclosed reaction chamber, which comprises a top end and a bottom end, wherein each of the solid inlet pipe and the fluid outlet pipe is connected to the reaction chamber in the vicinity of its top end, and each of the solid outlet pipe and the first fluid inlet pipe is connected to the reaction chamber in the vicinity of its bottom end; wherein
the carbonated water comprises HCO₃″, and the carbon dioxide scavenger comprises Ca(OH)₂;
step (III) comprises:
hydrating the Ca(OH)₂ in the carbonated water to form an aqueous Ca(OH)₂ composition and inserting the formed composition into the reaction chamber through the fluid inlet pipe;
inserting CaCO₃ seeds into the reaction chamber through the solid inlet pipe in the vicinity of the reaction chamber top end and fluidizing said seeds, thereby inducing precipitation of CaCO₃ formed from a chemical reaction between the HCO₃⁻ and the Ca(OH)₂, so that the formed CaCO₃ is sinking to the bottom end of the reaction chamber and the decarbonated water flows in the direction of the top end of the reaction chamber; and
evacuating the decarbonated water from the top end of the reaction chamber through the fluid outlet pipe; and
step (IV) comprises evacuating the CaCO₃ from the bottom end of the reaction chamber through the solid outlet pipe.

According to some embodiments, the carbon dioxide scavenger is Ca(OH)₂, wherein the fluidized bed pellet reactor further comprises a solid inlet pipe, wherein step (III) further comprises inserting seeds of the CaCO₃ into the reaction chamber through the solid inlet pipe and fluidizing the seeds in the reaction chamber to a fluidized grains height, thereby inducing precipitation and maturation of CaCO₃ pellets.

According to some embodiments, the fluidized grains height is in the range of 0.6 meter to 12.4 meter.

According to some embodiments, the carbon dioxide scavenger is Ca(OH)₂, wherein the fluidized bed pellet reactor further comprises a solid inlet pipe, wherein step (III) further comprises inserting seeds of the Ca(OH)₂ into the reaction chamber through the solid inlet pipe and fluidizing the seeds in the reaction chamber, thereby inducing precipitation and maturation of CaCO₃.

According to some embodiments, (III) comprises inserting the carbonated water into the reaction chamber through the first fluid inlet pipe at a first superficial velocity.

According to some embodiments, the particle size of the seeds of CaCO₃ is in the range of 0.077-0.094 millimeters, the particle size of the precipitated CaCO₃ pellets is in the range of 0.183-0.240 millimeters, the first superficial velocity is in the range of 20 to 30 meters per hour, the fluidized grains height in the range of 1.1-2.4 meters and the Ca(OH)₂: total inorganic carbonated species in the carbonated water ratio is in the range of 9:10 to 10:10 mol/mol; or the particle size of the seeds of CaCO₃ is in the range of 0.077-0.094 millimeters, the particle size of the precipitated CaCO₃ pellets is in the range of 0.183-0.240 millimeters, the first superficial velocity is in the range of 20 to 30 meters per hour, the fluidized grains height in the range of 0.6-1.3 meters and the Ca(OH)₂: total inorganic carbonated species in the carbonated water ratio is in the range of 8:10 to 9:10 mol/mol; or
the particle size of the seeds of CaCO₃ is in the range of 0.077-0.094 millimeters, the particle size of the precipitated CaCO₃ pellets is in the range of 0.183-0.240 millimeters, the first superficial velocity is in the range of 20 to 30 meters per hour, the fluidized grains height in the range of 0.3-0.7 meters and the Ca(OH)₂: total inorganic carbonated species in the carbonated water ratio is in the range of 5:10 to 8:10 mol/mol; or
the particle size of the seeds of CaCO₃ is in the range of 0.094-0.109 millimeters, the particle size of the precipitated CaCO₃ pellets is in the range of 0.240-0.291 millimeters, the first superficial velocity is in the range of 30 to 40 meters per hour, the fluidized grains height in the range of 2.2-3.9 meters and the Ca(OH)₂: total inorganic carbonated species in the carbonated water ratio is in the range of 9:10 to 10:10 mol/mol; or
the particle size of the seeds of CaCO₃ is in the range of 0.094-0.109 millimeters, the particle size of the precipitated CaCO₃ pellets is in the range of 0.240-0.291 millimeters, the first superficial velocity is in the range of 30 to 40 meters per hour, the fluidized grains height in the range of 1.2-2.1 meters and the Ca(OH)₂: total inorganic carbonated species in the carbonated water ratio is in the range of 8:10 to 9:10 mol/mol; or the particle size of the seeds of CaCO₃ is in the range of 0.094-0.109 millimeters, the particle size of the precipitated CaCO₃ pellets is in the range of 0.240-0.291 millimeters, the first superficial velocity is in the range of 30 to 40 meters per hour, the fluidized grains height in the range of 0.6-1.1 meters and the Ca(OH)₂: total inorganic carbonated species in the carbonated water ratio is in the range of 5:10 to 8:10 mol/mol; or
the particle size of the seeds of CaCO₃ is in the range of 0.109-0.122 millimeters, the particle size of the precipitated CaCO₃ pellets is in the range of 0.291-0.338 millimeters, the first superficial velocity is in the range of 40 to 50 meters per hour, the fluidized grains height in the range of 3.6-5.6 meters and the Ca(OH)₂: total inorganic carbonated species in the carbonated water ratio is in the range of 9:10 to 10:10 mol/mol; or
the particle size of the seeds of CaCO₃ is in the range of 0.109-0.122 millimeters, the particle size of the precipitated CaCO₃ pellets is in the range of 0.291-0.338 millimeters, the first superficial velocity is in the range of 40 to 50 meters per hour, the fluidized grains height in the range of 1.9-3 meters and the Ca(OH)₂: total inorganic carbonated species in the carbonated water ratio is in the range of 8:10 to 9:10 mol/mol; or
the particle size of the seeds of CaCO₃ is in the range of 0.109-0.122 millimeters, the particle size of the precipitated CaCO₃ pellets is in the range of 0.291-0.338 millimeters, the first superficial velocity is in the range of 40 to 50 meters per hour, the fluidized grains height in the range of 1-1.6 meters and the Ca(OH)₂: total inorganic carbonated species in the carbonated water ratio is in the range of 5:10 to 8:10 mol/mol; or
the particle size of the seeds of CaCO₃ is in the range of 0.122-0.133 millimeters, the particle size of the precipitated CaCO₃ pellets is in the range of 0.338-0.381 millimeters, the first superficial velocity is in the range of 50 to 60 meters per hour, the fluidized grains height in the range of 5.2-7.6 meters and the Ca(OH)₂: total inorganic carbonated species in the carbonated water ratio is in the range of 9:10 to 10:10 mol/mol; or
the particle size of the seeds of CaCO₃ is in the range of 0.122-0.133 millimeters, the particle size of the precipitated CaCO₃ pellets is in the range of 0.338-0.381 millimeters, the first superficial velocity is in the range of 50 to 60 meters per hour, the fluidized grains height in the range of 2.8-4.1 meters and the Ca(OH)₂: total inorganic carbonated species in the carbonated water ratio is in the range of 8:10 to 9:10 mol/mol; or
the particle size of the seeds of CaCO₃ is in the range of 0.122-0.133 millimeters, the particle size of the precipitated CaCO₃ pellets is in the range of 0.338-0.381 millimeters, the first superficial velocity is in the range of 50 to 60 meters per hour, the fluidized grains height in the range of 1.5-2.2 meters and the Ca(OH)₂: total inorganic carbonated species in the carbonated water ratio is in the range of 5:10 to 8:10 mol/mol; or
the particle size of the seeds of CaCO₃ is in the range of 0.133-0.144 millimeters, the particle size of the precipitated CaCO₃ pellets is in the range of 0.381-0.423 millimeters, the first superficial velocity is in the range of 60 to 70 meters per hour, the fluidized grains height in the range of 7.2-9.9 meters and the Ca(OH)₂: total inorganic carbonated species in the carbonated water ratio is in the range of 9:10 to 10:10 mol/mol; or
the particle size of the seeds of CaCO₃ is in the range of 0.133-0.144 millimeters, the particle size of the precipitated CaCO₃ pellets is in the range of 0.381-0.423 millimeters, the first superficial velocity is in the range of 60 to 70 meters per hour, the fluidized grains height in the range of 3.8-5.3 meters and the Ca(OH)₂: total inorganic carbonated species in the carbonated water ratio is in the range of 8:10 to 9:10 mol/mol; or
the particle size of the seeds of CaCO₃ is in the range of 0.133-0.144 millimeters, the particle size of the precipitated CaCO₃ pellets is in the range of 0.381-0.423 millimeters, the first superficial velocity is in the range of 60 to 70 meters per hour, the fluidized grains height in the range of 2.1-2.8 meters and the Ca(OH)₂: total inorganic carbonated species in the carbonated water ratio is in the range of 5:10 to 8:10 mol/mol; or
the particle size of the seeds of CaCO₃ is in the range of 0.144-0.154 millimeters, the particle size of the precipitated CaCO₃ pellets is in the range of 0.423-0.462 millimeters, the first superficial velocity is in the range of 70 to 80 meters per hour, the fluidized grains height in the range of 9.3-12.4 meters and the Ca(OH)₂: total inorganic carbonated species in the carbonated water ratio is in the range of 9:10 to 10:10 mol/mol; or
the particle size of the seeds of CaCO₃ is in the range of 0.144-0.154 millimeters, the particle size of the precipitated CaCO₃ pellets is in the range of 0.423-0.462 millimeters, the first superficial velocity is in the range of 70 to 80 meters per hour, the fluidized grains height in the range of 4.9-6.6 meters and the Ca(OH)₂: total inorganic carbonated species in the carbonated water ratio is in the range of 8:10 to 9:10 mol/mol; or
the particle size of the seeds of CaCO₃ is in the range of 0.144-0.154 millimeters, the particle size of the precipitated CaCO₃ pellets is in the range of 0.423-0.462 millimeters, the first superficial velocity is in the range of 70 to 80 meters per hour, the fluidized grains height in the range of 2.6-3.5 meters and the Ca(OH)₂: total inorganic carbonated species in the carbonated water ratio is in the range of 5:10 to 8:10 mol/mol.

According to some embodiments, the carbon removal system comprises a calciner, wherein step (VI) comprises dissociating the scavenged carbon species in the calciner.

According to some embodiments, the calciner is a circulating fluidized bed calciner.

According to some embodiments, the calciner comprises a solid inlet pipe, a gas outlet pipe and a heating chamber, wherein each of the pipes is in fluid communication with the heating chamber, wherein step (VI) comprises:
inserting the scavenged carbon species isolated in step (IV) through the solid inlet pipe into the heating chamber;
elevating the temperature within the heating chamber, to form carbon dioxide gas and the decarbonated solid material; and
evacuating the carbon dioxide gas through the gas outlet pipe.

According to some embodiments, the heating chamber is a combustion chamber;

wherein the calciner further comprises a first gas inlet pipe, and a second gas inlet pipe, each is in fluid communication with the combustion chamber, wherein elevating the temperature within the heating chamber in step (VI) comprises inserting a combustible gas through the first gas inlet pipe into the combustion chamber, inserting oxygen gas through the second gas inlet pipe combustion chamber, and combusting the gas mixture in the combustion chamber to elevate the temperature.

According to some embodiments, the calciner further comprises a solid outlet in fluid communication with the heating chamber, wherein step (VI) further comprises evacuating the decarbonated solid material through the solid outlet.

According to some embodiments, the carbon removal system comprises a slaker, wherein the process further comprises step (VIII) of processing the decarbonated solid material formed in step (VI) into a carbon dioxide scavenger in the slaker.

According to some embodiments, the slaker is a circulating fluidized bed steam slaker.

According to some embodiments, the slaker comprises a solid inlet pipe, a steam inlet pipe, an outlet pipe and a slaking chamber, wherein each of the pipes is in fluid communication with the slaking chamber, wherein step (VIII) comprises:
inserting the decarbonated solid material formed in step (VI) into the slaking chamber through the solid inlet pipe;
inserting steam into the slaking chamber through the steam inlet pipe;
reacting the steam with the decarbonated solid material to form a carbon dioxide scavenger; and
evacuating the carbon dioxide scavenger through the outlet pipe.

According to some embodiments, there is provided a carbon removal system comprising:
a fluidized bed pellet reactor comprising:
a first fluid inlet pipe,
a second fluid inlet pipe,
a solid inlet pipe,
a fluid outlet pipe,
a solid outlet pipe, and
an enclosed reaction chamber, which comprises a top end and a bottom end,
wherein each of the solid inlet pipe and the fluid outlet pipe is connected to the reaction chamber in the vicinity of its top end, and each of the solid outlet pipe, the first fluid inlet pipe and the second fluid inlet pipe is connected to the reaction chamber in the vicinity of its bottom end;
a circulating fluidized bed calciner comprising:
a solid inlet pipe,
a gas outlet pipe,
a first gas inlet pipe,
a second gas inlet pipe,
a solid outlet pipe, and
a combustion chamber,
wherein each of the pipes is in fluid communication with the combustion chamber;
and
a circulating fluidized bed steam slaker comprising:
a solid inlet pipe,
a steam inlet pipe,
an outlet pipe and
a slaking chamber,
wherein each of the pipes is in fluid communication with the slaking chamber;
wherein the solid outlet pipe of the pellet reactor is in fluid communication with the solid inlet pipe of the calciner, wherein the solid outlet pipe of the calciner is in fluid communication with the solid inlet pipe of the slaker, and wherein the outlet pipe of the slaker is in fluid communication with the liquid inlet pipe of the pellet reactor.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

In addition to the exemplary aspects and embodiments described above, further aspects and embodiments will become apparent by reference to the figures and by study of the following detailed descriptions.

### BRIEF DESCRIPTION OF THE DRAWINGS

Examples illustrative of embodiments are described below with reference to figures attached hereto. In the figures, identical structures, elements or parts that appear in more than one figure are generally labeled with a same numeral in all the figures in which they appear. Alternatively, elements or parts that appear in more than one figure may be labeled with different numerals in the different figures in which they appear. Dimensions of components and features shown in the figures are generally chosen for convenience and clarity of presentation and are not necessarily shown in scale. The figures are listed below.

FIG. 1A is a schematic illustration of a method for removing carbon dioxide from a carbonated water source, according to some embodiments.

FIG. 1B is a schematic illustration of a method for removing carbon dioxide from a carbonated water source using a carbon removal system comprising: a fluidized bed pellet reactor, a calciner and a steam slaker, according to some embodiments.

FIG. 2 is a schematic cross-section illustration of a pellet reactor, according to some embodiments.

FIG. 3 is a schematic illustration of a circulating fluidized bed calciner, according to some embodiments.

FIG. 4 is a schematic illustration of a circulating fluidized bed steam slaker, according to some embodiments.

FIG. 5 is a schematic illustration of a fluidized bed pellet reactor, according to some exemplary embodiments.

### DETAILED DESCRIPTION OF THE INVENTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

The methods of the present invention are suitable for carbon dioxide removal from large water reservoirs, such as seas and oceans.

According to some embodiments, the present invention provides a method for removing carbon dioxide (CO₂). According to some embodiments, the present invention provides a method for removing carbon dioxide (CO₂) from a natural or unnatural carbonated water source. According to some embodiments, there is provided a method of isolating carbon dioxide from a natural or unnatural carbonated water source to provide isolated carbon dioxide and decarbonated water, the method includes the steps as disclosed herein (e.g., steps (I)-(VII) or (I)-(VIII), performed once or repeatedly/cyclically). According to some embodiments, there is provided a method of removing carbon dioxide from a natural or unnatural carbonated water source and storing the carbon dioxide, the method includes the steps as disclosed herein (e.g., steps (I)-(VII) or (I)-(VIII), performed once or repeatedly/cyclically).

According to some embodiments, the method comprises the steps of:
(I) providing carbonated water from a natural or unnatural carbonated water source, wherein the carbonated water comprises an inorganic carbonated species selected from the group consisting of: CO₂, H₂CO₃, HCO₃⁻ and a combination thereof, at a first concentration;
(II) providing a carbon dioxide scavenger;
(III) contacting the carbonated water with the carbon dioxide scavenger to form a solid water-insoluble scavenged carbon species and decarbonated water;
(IV) isolating the scavenged carbon species from the decarbonated water, wherein the decarbonated water has final alkalinity, which is in the range of 75% to 125% of the initial alkalinity;
(V) isolating the scavenged carbon species from the decarbonated water;
(VI) dissociating the scavenged carbon species to form carbon dioxide and a decarbonated solid material; and
(VII) capturing the carbon dioxide formed in step (VI).

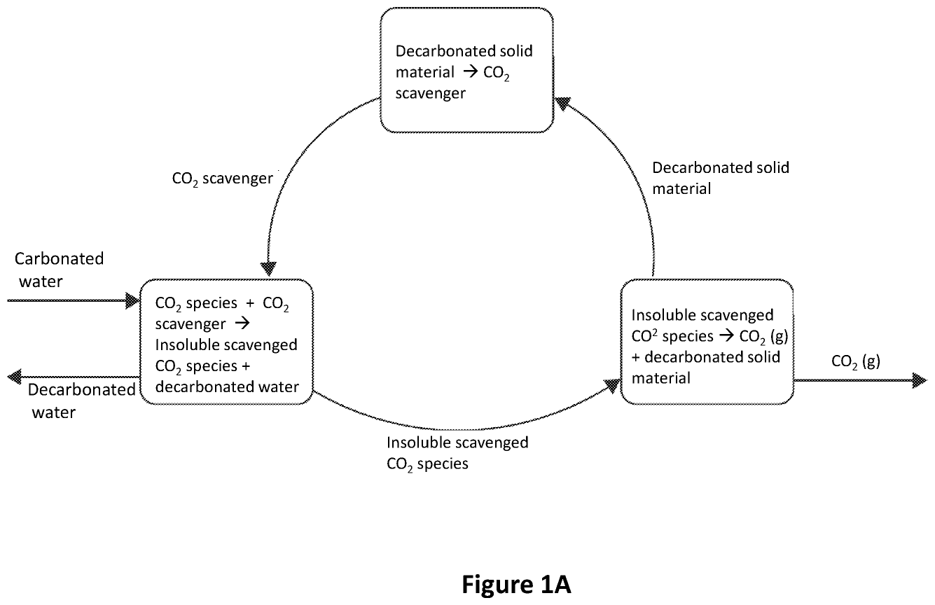

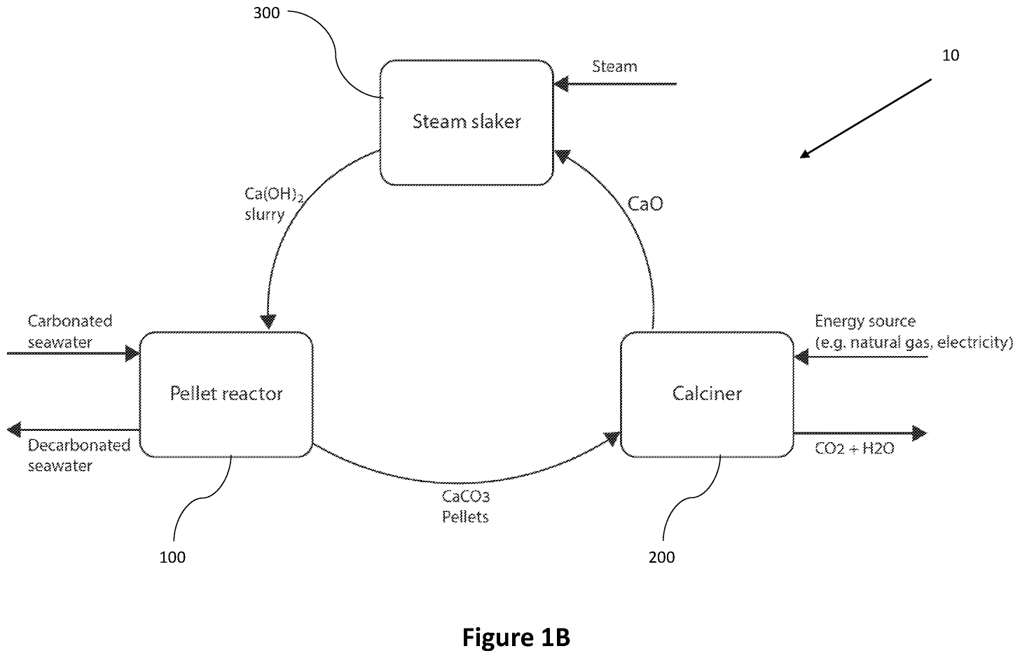

FIG. 1A is a schematic illustration of the method of the present invention, according to some embodiments. FIG. 1B is a schematic illustration of the present method, performed with a specific carbon removal system 10 and using specific carbon dioxide scavenger, Ca(OH)₂, which leads to specific intermediates (CaCO₃ and CaO), as elaborated herein, according to some embodiments. However, some embodiments of the present invention are not limited to the system or specific starting materials/intermediate materials.

According to some embodiments, in the present process, which includes three main modules (see FIGS. 1A-1B), lime (Ca(OH)₂) is used to precipitate inorganic carbon from seawater as calcium carbonate (CaCO₃), which is then calcinated to release CO₂ as a high-concentration gas stream, while coincidently producing quicklime (CaO). In the next steps, according to some embodiments, the CaO is slaked to regenerate the lime which may then be used for additional carbon dioxide removal cycles.

As detailed above, the fraction of CO₂ in the atmosphere, 0.04%, is very small, which necessitates large contact area of any air-based carbon dioxide removal apparatus to capture significant quantities of CO₂ from the air, and consequently large land area required for air-based carbon dioxide removal plants (typically 0.4 square kilometer for the capture of million ton of CO₂ per year). As a result, the large land area of the plants constrains the locations in which they can be constructed and makes them expensive to build and maintain. The method of the present invention, however, overcomes this hurdle by removing CO₂ from natural carbonated water sources (e.g., oceans) rather than from the air. The molar concentration of the dissolved inorganic carbonated species within oceans and seas is typically 140 times larger than that of the air, which allows plants based on the method of the present invention to be much more efficient in land area compared to air-based carbon dioxide removal plants.

Advantageously, the natural carbonated water source, from which the carbonated water is drawn may be an ocean or sea in the vicinity of oil and natural gas off-shore or coastal drilling rigs, according to some embodiments. Specifically, transport of oil and gas from such drilling rigs to carbon dioxide removal plants in their vicinity is cheaper which allows more economical removal of carbon dioxide.

Some state-of-the-art methods for carbon dioxide removal, absorb CO₂ from air by passing the air through various alkaline solutions, which are intended to form a basic carbonate (CO₃⁻²) solutions, which are then used to form insoluble CaCO₃ through complexation with divalent Ca⁺² cations. The CaCO₃ is then dissociated to form CO₂, which may then be captured for storage. The present method, however, avoids some of the drawbacks of the known methods. First, the present method avoids air-handling, which is specifically cumbersome due to the low CO₂ concentration therein. Specifically, weight-per-volume (W/V) concentrations of any constituent in a gaseous composition is low, due to the inherent diluted nature of non-condensed phases (i.e., gas is much less condensed than solids and liquids). Also, the typical molar concentration of CO₂ in air, 16 μM, is, independently, very small, which makes CO₂ harvesting from air even more challenging. Second, the present method does not require any constant supply of materials or reagents besides carbonated water and an energy source. This allows plants based on the current method to be constructed in locations far away from manufacturers of said materials and reagents.

Moreover, the present method also avoids three major drawbacks of current state-of-the-art methods from carbon dioxide removal from carbonated water sources (e.g. oceans). First, the present method does not generate any chemical by-products such as acids that are difficult to handle at large scales. Second, the present method does not use gas separation membranes or electrodes which have short lifetime and require significant maintenance. Third, according to some embodiments, the reactions of step III of the present method preserve the alkalinity of the carbonated water as the carbon dioxide is precipitated as a solid scavenged carbon species. As a result, the decarbonated water that is returned to the natural carbonated water source reabsorbs from the air, over time, the removed carbon dioxide, because the decarbonated water reaches chemical equilibrium with the vapor pressure of the CO₂ in the atmosphere, which, for conserved alkalinity, results in the same concentration of inorganic carbonated species. This reabsorption leads to a net atmospheric removal of carbon dioxide and subsequent mitigation of the greenhouse effect and climate change. Third, according to some embodiments, the chemical composition of the re-carbonated water, which form from the decarbonated water subsequent to their reabsorption of carbon dioxide from the atmosphere, is identical to the chemical composition of the carbonated water in the carbonated water source. Thus, returning the decarbonated water to the natural carbonated water source does not have any negative environmental effect, according to some embodiments.

Thus, the present invention provides a novel method without excess steps, which is more efficient in land area and logistics compared to current methods and does not have any negative environmental impact.

According to some embodiments, the steps (I)-(IV) are devoid of air treatment.

According to some embodiments, the method is devoid of air treatment.

It is to be understood that “air treatment” is not equivalent to “gas treatment”, which is required for CO₂ gas removal processes.

Thus, according to some embodiments, steps (I)-(III) are devoid of gas treatment. According to some embodiments, step (I) is devoid of gas treatment. According to some embodiments, step (II) is devoid of gas treatment. According to some embodiments, step (III) is devoid of gas treatment. According to some embodiments, step (IV) is devoid of gas treatment. According to some embodiments, step (VI) is devoid of gas treatment. According to some embodiments, steps (I)-(IV) are devoid of gas treatment. According to some embodiments, steps (I)-(VI) are devoid of gas treatment. According to some embodiments, the only gas treatment performed in the present method is the capturing of CO₂ in step (VII).

According to some embodiments, each one of steps (I) to (IV) is devoid of gas treatment.

According to some embodiments, the method further comprises providing a carbon removal system 10. The carbon removal system 10 is as detailed herein. Thus, according to some embodiments, the present invention further provides a carbon removal system 10 as is detailed herein (e.g., in FIGS. 1B, 2, 3 and 4). According to some embodiments, at least one of steps (I) to (VIII) is carried out within the carbon removal system 10. According to some embodiments, at least one of steps (I) to (VII) is carried out within the carbon removal system 10. According to some embodiments, each one of steps (I) to (VIII) is carried out within the carbon removal system 10. According to some embodiments, each one of steps (I) to (VII) is carried out within the carbon removal system 10.

The system may be conveniently positioned on land or sea, according to some embodiments. Each possibility represents a separate embodiment of the invention. For example, the system may be land-based system that is in a coastal region, e.g., close to a source of sea water, or even an interior location, where water is piped into the system from a carbonated water source, e.g., ocean. Alternatively, the system may be a water-based system, i.e., a system that is present on or in water, according to some embodiments. Such a system may be present on a boat, an ocean-based platform etc., as desired. According to some embodiments, the system is positioned in the vicinity of a natural gas off-shore drilling rig.

The system is further elaborated herein. It may include any one or each of three main modules: a pellet reactor, a calciner and a slaker, each of which are detailed below and in the Figures.

As detailed herein, step (I) of the present invention includes providing carbonated water from a carbonated water source, e.g., a natural carbonated water source, wherein the carbonated water comprises an inorganic carbonated species selected from the group consisting of: CO₂, H₂CO₃, HCO₃⁻ and a combination thereof, at a first concentration.

Inorganic carbonated species present in seawater are inorganic and typically include CO₂, H₂CO₃, HCO₃⁻ and CO₃⁻². They are also commonly termed dissolved inorganic carbon (DIC) species, and their relative ratio is pH depended.

Within the present disclosure, the term “DIC concentration” should be interpreted as the sum of the molar concentrations of CO₂, H₂CO₃, HCO₃⁻ and CO₃⁻² within a mixture, e.g., an aqueous mixture. For example, an aqueous mixture comprising 0.1M HCO₃⁻ and 0.15M CO₃⁻² and devoid of other DIC species is said to have a DIC concentration of 0.25M.

According to some embodiments, the carbonated water comprises HCO₃. According to some embodiments, the carbonated water further comprises CO₃⁻². According to some embodiments, the carbonated water comprises HCO₃⁻ and CO₃⁻².

According to some embodiments, the carbonated water comprises at least 0.1 HCO₃⁻ ions per one CO₃⁻² ion. According to some embodiments, the carbonated water comprises at least 0.5 HCO₃⁻ ions per one CO₃⁻² ion. According to some embodiments, the carbonated water comprises at least 1 HCO₃⁻ ion per one CO₃⁻² ion. According to some embodiments, the carbonated water comprises at least 1.5 HCO₃⁻ ions per one CO₃⁻² ion. According to some embodiments, the carbonated water comprises at least 2 HCO₃⁻ ions per one CO₃⁻² ion. According to some embodiments, the carbonated water comprises at least 2.3 HCO₃⁻ ions per one CO₃⁻² ion. According to some embodiments, the carbonated water comprises at least 3 HCO₃⁻ ions per one CO₃⁻² ion. According to some embodiments, the carbonated water comprises at least 5 HCO₃⁻ ions per one CO₃⁻² ion. According to some embodiments, the carbonated water comprises at least 6 HCO₃⁻ ions per one CO₃⁻² ion. According to some embodiments, the carbonated water comprises at least 10 HCO₃⁻ ions per one CO₃⁻² ion. According to some embodiments, the carbonated water comprises at least 20 HCO₃⁻ ions per one CO₃⁻² ion. According to some embodiments, the carbonated water comprises at least 50 HCO₃⁻ ions per one CO₃⁻² ion. According to some embodiments, the carbonated water comprises at least 100 HCO₃⁻ ions per one CO₃⁻² ion. According to some embodiments, the carbonated water comprises at least 1000 HCO₃⁻ ions per one CO₃⁻² ion.

According to some embodiments, the carbonated water comprises 0.1 to 100, 1 to 100, 2 to 3000, 3 to 3000, 3-1000, 3-500, 3-250 or 3-100 HCO₃⁻ ions per one CO₃⁻² ion. Each possibility represents a separate embodiment of the invention.

According to some embodiments, the carbonated water provided to step (I) comprises an aqueous solution. According to some embodiments, the carbonated water provided to step (I) comprises an aqueous solution of the inorganic carbonated species. According to some embodiments, the carbonated water provided to step (I) comprises an aqueous solution comprising bicarbonate, HCO₃.

The term “solution” as used herein broadly refers to a combination, mixture and/or admixture of ingredients having at least one liquid component. Thus, the term “aqueous solution” refers to any solution, in which at least one of its liquid components is water, wherein at least 50% of its weight is water. Aqueous solutions typically include water in greater quantity or volume than a solute. Preferably, “solution” refers broadly to a mixture of miscible substances, where one substance dissolves in a second substance. More preferably, in a solution the essential components are homogeneously mixed and that the components are subdivided to such an extent that there is no appearance of light scattering visible to the naked eye when a one-inch diameter bottle of the mixture is viewed in sunlight. It is also to be understood that water drawn from seas are considered to include a solution, even if the drawn water includes insoluble contaminants mixed or dispersed with the aqueous solution.

The term “natural water source” includes seas, oceans, rivers, lakes, natural pools, inland water bodies, and the like. Typically, in natural water sources, the concentration of inorganic carbonated species is at least 0.1 millimolar (mM), 0.25 millimolar (mM), 0.5 millimolar (mM), at least 1 mM, at least 1.5 mM, at least 2 mM, at least 3 mM, at least 4 mM or at least 5 mM according to some embodiments. Each possibility represents a separate embodiment of the invention. It is to be understood that said concentrations are present without intentional human intervention intended to increase to CO₂ concentration.

According to some embodiments, the natural water source is a freshwater source or a saltwater source. According to some embodiments, the natural water source is a freshwater source. According to some embodiments, the natural water source is a saltwater source.

The saltwater source from which the carbonated saltwater is obtained may be a naturally occurring source, such as a sea, ocean, lake, swamp, estuary, lagoon, etc., or a man-made source. According to some embodiments, the saltwater source is an ocean or sea and the saltwater feedwater is seawater. Saltwaters of interest are ones which contain one or more alkaline earth metals, e.g., magnesium, calcium, etc., such that they may be viewed as alkaline-earth-metal-containing waters. Examples of such waters are those that include calcium in amounts ranging from 50 ppm to 20,000 ppm, such as 200 ppm to 5000 ppm and including 400 ppm to 1000 ppm.

According to some embodiments, the natural carbonated water source is selected from the group consisting of: an ocean, a sea, a river, a lake and an inland water body. Each possibility represents a separate embodiment of the invention. According to some embodiments, the carbonated water source is a sea or an ocean. According to some embodiments, the carbonated water source is a sea. According to some embodiments, the carbonated water source is an ocean.

Typically, seawater (i.e., water derived from oceans or other seas) has a salinity of between 31 g/kg and 38 g/kg. Thus, according to some embodiments, the natural carbonated water source has a total salt concentration of at least 1% w/w. According to some embodiments, the natural carbonated water source has a total salt concentration of at least 1.5% w/w. According to some embodiments, the natural carbonated water source has a total salt concentration of at least 2% w/w. According to some embodiments, the natural carbonated water source has a total salt concentration of at least 2.5% w/w. According to some embodiments, the natural carbonated water source has a total salt concentration of at least 3% w/w. According to some embodiments, the natural carbonated water source has a total salt concentration in the ranges of 1-6% w/w, 2-5% w/w or 3-4% w/w. Each possibility represents a separate embodiment of the invention. Sweetwater, e.g., in lakes and rivers, has lower salinity values, typically below 1%. Thus, according to some embodiments, the natural carbonated water source has a total salt concentration of 0% to 1% w/w. According to some embodiments, the natural carbonated water source has a total salt concentration of 0.05% to 0.5% w/w.

The term “salinity” as used herein refers to the total concentration of dissolved salts in a given sample of water, as measured by conductivity, and expressed as a mass of salts in a given volume of solution, expressed in grams per liter (gr/L) or grams per kilogram (gr/kg).

It is further contemplated that the carbonated water source is a sea and the carbonated water is seawater used by power plants or other industrial facilities for cooling.

The term “inland water” refers to water of the interior that does not border upon marginal or high seas or is above the rise and fall of the tides.

Alternatively, according to some embodiments, the carbonated water source is an unnatural carbonated water source. According to some embodiments, the unnatural carbonated water source is a desalination plant. Specifically, brine from desalination plants is contemplated as the source of water to the present method. Thus, according to some embodiments, the carbonated water source is a desalination plant and the carbonated water is brine from said desalination plant.

According to some embodiments, the carbonated water source has an area of at least 1, at least 2, at least 5, at least 10, at least 20, at least 30, at least 50, at least 75 or at least 100 km². Each possibility represents a separate embodiment of the invention. According to some embodiments, the carbonated water source has an area of at least 100 km².

According to some embodiments, the carbonated water source of step (I) may be any natural or man-made water reservoir, which has an area of at least 1, at least 2, at least 5, at least 10, at least 20, at least 30, at least 50, at least 75 or at least 100 km². Each possibility represents a separate embodiment of the invention.

When atmospheric CO₂ dissolves in seawater, the majority of it reacts with water molecules to form carbonic acid, H₂CO₃, which is then deprotonated and forms a mix of inorganic carbon species within the carbonated water, including, H₂CO₃, HCO₃⁻, and CO₃⁻², whose total concentration in seawater is typically about 2.3 mM.

According to some embodiments, the natural or unnatural carbonated water source has substantially the same chemical composition of the carbonated water provided in step (I). According to some embodiments, step (I) is devoid of treatment of the carbonated water. By specifying that step (I) is devoid of treatment of the carbonated water it is to be understood that the composition of the carbonated water is substantially unaffected prior to its contacting with the carbon dioxide scavenger.

The phrase “natural or unnatural carbonated water source has substantially the same chemical composition of the carbonated water provided in step (I)” as used herein is intended to mean that the each of the solute compounds present in the carbonated water source appears in the carbonated water at substantially the same concentration and the pH of the carbonated water source is substantially the same as of the carbonated water. The phrase “substantially the same concentration” refers to +10%, +5% or +1% of the concentration of each solute. The phrase “substantially the same pH” refers to +1, +0.5 or +0.2 pH units. It is to be understood that any visible undissolved contaminants within the carbonated water source are not included as part of the carbonated water source composition. For example, if sea is the water source, sand, rocks, marine organisms etc., which may be drawn therefrom together with the carbonated water, may be present, but are neither considered as part of the water source, nor they are considered as part of the carbonated water. Thus, similarly, the phrase “step (I) is devoid of treatment of the carbonated water” allows simple size filtration of such visible undissolved contaminants as part of step (I).

As detailed herein, the carbonated water comprises an inorganic carbonated species selected from the group consisting of: CO₂, H₂CO₃, HCO₃⁻ and a combination thereof, at a first concentration. According to some embodiments, the inorganic carbonated species comprises CO₂ (aq). According to some embodiments, the inorganic carbonated species comprises H₂CO₃ (aq). According to some embodiments, the inorganic carbonated species comprises HCO₃⁻ (aq).

According to some embodiments, the first concentration is at least 0.1 millimolar (mM). According to some embodiments, the first concentration is at least 0.25 millimolar (mM). According to some embodiments, the first concentration is at least 0.5 millimolar (mM). According to some embodiments, the first concentration is at least 0.75 millimolar (mM). According to some embodiments, the first concentration is at least 1 millimolar (mM).

According to some embodiments, the first concentration is at least 1.25 mM. According to some embodiments, the first concentration is at least 1.5 mM. According to some embodiments, the first concentration is at least 1.75 mM. According to some embodiments, the first concentration is at least 2 mM. According to some embodiments, the first concentration is at least 2.25 mM. According to some embodiments, the first concentration is in the range of 1.0 to 50.0 mM.

According to some embodiments, the first concentration is in the range of 1.0 to 25.0 mM. According to some embodiments, the first concentration is in the range of 1.0 to 10.0 mM. According to some embodiments, the first concentration is in the range of 1.0 to 5.0 mM. According to some embodiments, the first concentration is in the range of 0.1 to 50.0 mM. According to some embodiments, the first concentration is in the range of 0.1 to 25.0 mM. According to some embodiments, the first concentration is in the range of 0.1 to 10.0 mM. According to some embodiments, the first concentration is in the range of 0.1 to 5.0 mM.

According to some embodiments, the carbonated water source comprises an inorganic carbonated species selected from the group consisting of: CO₂, H₂CO₃, HCO₃⁻ and a combination thereof at a total concentration of is at least 0.1 mM, at least 0.25 mM, at least 0.5 mM, at least 0.75 mM, at least 1 mM, at least 1.25 mM, at least 1.5 mM, at least 1.75 mM, at least 2.0 mM or at least 2.25 mM. Each possibility represents a separate embodiment of the invention. According to some embodiments, the total concentration in the carbonated water source is in the range of 1.0 to 50.0 mM, 1.0 to 25.0 mM, 1.0 to 10.0 mM or 1.0 to 5.0 mM. Each possibility represents a separate embodiment of the invention. According to some embodiments, the total concentration in the carbonated water source is in the range of 0.1 to 50.0 mM, 0.1 to 25.0 mM, 0.1 to 10.0 mM or 0.1 to 5.0 mM. Each possibility represents a separate embodiment of the invention.

According to some embodiments, the salinity of the carbonated water of step (I) is in the range of 0.5 to 100 g/L, 30-40 g/L, 0.5-3 g/L, 3-20 g/L, 20-50 g/L, 50-65 g/L or 0.0001 to 0.5 g/L. Each possibility represents a separate embodiment of the invention.

The ratio between the concentration of the carbonates and bicarbonate ions is determined by the pH, temperature, and salinity of the water reservoir. For example, for seawater at 25° C. having typical pH of 8.2, there are 6 bicarbonate ions for each carbonate ion.

Thus, carbonated water comprises HCO₃⁻ at a concentration of at least 0.1 millimolar (mM). Thus, carbonated water comprises HCO₃⁻ at a concentration of at least 0.25 millimolar (mM). Thus, carbonated water comprises HCO₃⁻ at a concentration of at least 0.5 millimolar (mM). Thus, carbonated water comprises HCO₃⁻ at a concentration of at least 0.75 millimolar (mM). According to some embodiments, the HCO₃⁻ concentration in the carbonated water is at least 1 mM. According to some embodiments, the HCO₃⁻ concentration in the carbonated water is at least 1.25 mM. According to some embodiments, the HCO₃⁻ concentration in the carbonated water is at least 1.5 mM. According to some embodiments, the HCO₃⁻ concentration in the carbonated water is at least 1.75 mM. According to some embodiments, the HCO₃⁻ concentration in the carbonated water is at least 2 mM. According to some embodiments, the HCO₃⁻ concentration in the carbonated water is at least 2.25 mM. According to some embodiments, the HCO₃⁻ concentration in the carbonated water is in the range of 0.5 to 10 mM, 0.5 to 5 mM, 0.5 to 4 mM or 0.5 to 3 mM. Each possibility represents a separate embodiment of the invention.

According to some embodiments, at least 25% mol/mol of the total inorganic carbonated species in the carbonated water of step (I) is HCO₃. According to some embodiments, at least 50% mol/mol of the total inorganic carbonated species in the carbonated water of step (I) is HCO₃″. According to some embodiments, at least 60% mol/mol of the total inorganic carbonated species in the carbonated water of step (I) is HCO₃.

The mol/mol unit, as used herein refers to a relation between the number of molecules of a first species and number of molecules of a second species within a specified volume, wherein the first species may include or be included in the second species. For example, in a solution of 0.2 mol CO₃⁻² and 0.8 mol HCO₃⁻, 20% mol/mol of the total inorganic carbonated species is CO₃⁻² and 80% mol/mol is HCO₃.

As, contrary to other CDR methods, the pH used in the present method is moderate rather than highly basic, the concentration of carbonate in the carbonated water source and carbonated water of the present method, is relatively low.

Thus, according to some embodiments, the carbonated water of step (I) comprises CO₃⁻² at a concentration of no more than 20 millimolar (mM). According to some embodiments, the CO₃⁻² concentration in the carbonated water is no more than 10 millimolar. According to some embodiments, the CO₃⁻² concentration in the carbonated water is no more than 5 millimolar. According to some embodiments, the CO₃⁻² concentration in the carbonated water is no more than 3 millimolar. According to some embodiments, the CO₃⁻² concentration in the carbonated water is no more than 1 millimolar. According to some embodiments, the CO₃⁻² concentration in the carbonated water is no more than 0.5 millimolar.

Similarly, according to some embodiments, the carbonated water source comprises CO₃⁻² at a concentration of no more than 20 millimolar (mM). According to some embodiments, the CO₃⁻² concentration in the carbonated water source is no more than 10 millimolar. According to some embodiments, the CO₃⁻² concentration in the carbonated water source is no more than 5 millimolar. According to some embodiments, the CO₃⁻² concentration in the carbonated water source is no more than 3 millimolar. According to some embodiments, the CO₃⁻² concentration in the carbonated water source is no more than 1 millimolar. According to some embodiments, the CO₃⁻² concentration in the carbonated water source is no more than 0.5 millimolar. According to some embodiments, the CO₃⁻² concentration in the carbonated water source is in the range of 0 to 2 millimolar.

According to some embodiments, the carbonated water of step (I) has pH of no more than 11.5. According to some embodiments, the carbonated water of step (I) has pH of no more than 11. According to some embodiments, the carbonated water of step (I) has pH of no more than 10.5. According to some embodiments, the carbonated water of step (I) has pH of no more than 10. According to some embodiments, the carbonated water of step (I) has pH of no more than 9.5. According to some embodiments, the carbonated water of step (I) has pH of no more than 9. According to some embodiments, the carbonated water of step (I) has pH of no more than 8.5. According to some embodiments, the carbonated water of step (I) has pH of at least 5. According to some embodiments, the carbonated water of step (I) has pH of at least 5.5. According to some embodiments, the carbonated water of step (I) has pH of at least 6. According to some embodiments, the carbonated water of step (I) has pH of at least 6.5. According to some embodiments, the carbonated water of step (I) has pH of at least 7. According to some embodiments, the carbonated water of step (I) has pH of at least 7.5. According to some embodiments, the carbonated water of step (I) has pH of at least 8. According to some embodiments, the carbonated water of step (I) has pH in the range of 6-11, 7-11, 7-10, 7-8.5, 7.5-8.4, 6-7, 7-8, 8-9, 9-10 or 10-11. Each possibility represents a separate embodiment of the invention.

Similarly, the source of carbonated water (e.g., the ocean) is moderately basic, according to some embodiments. According to some embodiments, the carbonated water source of step (I) has pH of no more than 10.5. According to some embodiments, the carbonated water source of step (I) has pH of no more than 10. According to some embodiments, the carbonated water source of step (I) has pH of no more than 9.5. According to some embodiments, the carbonated water source of step (I) has pH of no more than 9. According to some embodiments, the carbonated water source of step (I) has pH of no more than 8.5. According to some embodiments, the carbonated water source of step (I) has pH of at least 5. According to some embodiments, the carbonated water source of step (I) has pH of at least 5.5. According to some embodiments, the carbonated water source of step (I) has pH of at least 6. According to some embodiments, the carbonated water source of step (I) has pH of at least 6.5. According to some embodiments, the carbonated water source of step (I) has pH of at least 7. According to some embodiments, the carbonated water source of step (I) has pH of at least 7.5. According to some embodiments, the carbonated water source of step (I) has pH of at least 8.

As detailed herein, according to some embodiments, step (II) of the present method comprises providing a carbon dioxide scavenger.

According to some embodiments, the carbon dioxide scavenger is a base. According to some embodiments, the carbon dioxide scavenger is a Lewis base.

Specifically basic materials are known

Specifically, carbon dioxide is a Lewis acid, as its carbon atom is electron poor, due to the chemical bonds with two oxygen atoms. Therefore, carbon dioxide is prone to reactions with basic compounds. Moreover, as elaborated above, the main inorganic carbonated species in the sea water is HCO₃⁻, which is slightly acidic, so that its reaction with a base will result in an acid-base reaction leading to CO₃⁻².

According to some embodiments, the carbon dioxide scavenger is an inorganic compound. According to some embodiments, the carbon dioxide scavenger is an inorganic base.

According to some embodiments, the carbon dioxide scavenger is a Ca⁺² salt.

According to some embodiments, the carbon dioxide scavenger is a Ca⁺² base. According to some embodiments, the carbon dioxide scavenger is an inorganic Ca⁺² basic salt.

In particular, as detailed herein, according to some embodiments, the carbon dioxide scavenger provided in step (II) is to react with the inorganic carbonated species (e.g., with HCO₃⁻) to form a water-insoluble scavenged carbon species. Thus, in order for the product scavenged species to be a water-insoluble solid, the counter-cation should be carefully selected, according to some embodiments. Calcium salts are often water-insoluble (CaCO₃ has aqueous solubility of 0.013 g/L at 25° C.), so calcium salts are advantageous for use as the carbon dioxide scavenger of the present method, according to some embodiments.

According to some embodiments, the carbon dioxide scavenger is Ca(OH)₂ or CaO. Each possibility represents a separate embodiment of the invention.

According to some embodiments, the carbon dioxide scavenger is Ca(OH)₂.

Advantageously, despite the very low aqueous solubility of CaCO₃, calcium hydroxide, Ca(OH)₂, is about 140 times more soluble (1.7-1.9 g/L at 0-20° C.), which is beneficial for the promotion of the reaction of step (III). Therefore, Ca(OH)₂ may be used as the present carbon dioxide scavenger.

According to some embodiments, the carbon dioxide scavenger is provided to step (II) as an aqueous mixture. According to some embodiments, the carbon dioxide scavenger is provided to step (II) as an aqueous solution.

According to some embodiments, the concentration of the carbon dioxide scavenger is at least 0.1 g/L. According to some embodiments, the concentration of the carbon dioxide scavenger is at least 0.25 g/L. According to some embodiments, the concentration of the carbon dioxide scavenger is at least 0.5 g/L. According to some embodiments, the concentration of the carbon dioxide scavenger is at least 1 g/L. According to some embodiments, the concentration of the carbon dioxide scavenger is at least 1.5 g/L. According to some embodiments, the concentration of the carbon dioxide scavenger provided in step (II) is at least 0.1 g/L. According to some embodiments, the concentration of the carbon dioxide scavenger provided in step (II) is at least 0.25 g/L. According to some embodiments, the concentration of the carbon dioxide scavenger provided in step (II) is at least 0.5 g/L. According to some embodiments, the concentration of the carbon dioxide scavenger provided in step (II) is at least 1 g/L. According to some embodiments, the concentration of the carbon dioxide scavenger provided in step (II) is at least 1.5 g/L. According to some embodiments, the concentration of the carbon dioxide scavenger in the mixture of step (III) is at least 0.006 g/L. According to some embodiments, the concentration of the carbon dioxide scavenger in the mixture of step (III) is at least 0.03 g/L. According to some embodiments, the concentration of the carbon dioxide scavenger in the mixture of step (III) is at least 0.06 g/L. According to some embodiments, the concentration of the carbon dioxide scavenger in the mixture of step (III) is at least 0.1 g/L. According to some embodiments, the concentration of the carbon dioxide scavenger in the mixture of step (III) is at least 0.2 g/L. According to some embodiments, the concentration of the carbon dioxide scavenger in the mixture of step (III) is at least 0.3 g/L. According to some embodiments, the concentration of the carbon dioxide scavenger in the mixture of step (III) is at least 0.4 g/L. According to some embodiments, the concentration of the carbon dioxide scavenger in the mixture of step (III) is at least 0.5 g/L. According to some embodiments, the concentration of the carbon dioxide scavenger in the mixture of step (III) is at least 1 g/L. According to some embodiments, the concentration of the carbon dioxide scavenger in the mixture of step (III) is at least 1.5 g/L.

However, highly basic solutions are corrosive and polluting. Also, in order to make the present method environmentally friendly and avoid waste, the decarbonated water (the water after step (III), where CO₂ species and CO₂ scavenger were consumed) should be in condition to be returned to the sea, according to some embodiments. For this to happen, it would be understood by the person skilled in the art that the carbon dioxide scavenger, should not form a highly basic composition, i.e., it should be present at moderate concentration, according to some embodiments.

According to some embodiments, the concentration of the carbon dioxide scavenger is no more than 100 g/L. According to some embodiments, the concentration of the carbon dioxide scavenger is no more than 50 g/L. According to some embodiments, the concentration of the carbon dioxide scavenger is no more than 25 g/L. According to some embodiments, the concentration of the carbon dioxide scavenger is no more than 10 g/L. According to some embodiments, the concentration of the carbon dioxide scavenger is no more than 5 g/L. According to some embodiments, the concentration of the carbon dioxide scavenger is no more than 2.5 g/L.

According to some embodiments, the concentration of the carbon dioxide scavenger provided in step (II) is no more than 100 g/L. According to some embodiments, the concentration of the carbon dioxide scavenger provided in step (II) is no more than 50 g/L. According to some embodiments, the concentration of the carbon dioxide scavenger provided in step (II) is no more than 25 g/L. According to some embodiments, the concentration of the carbon dioxide scavenger provided in step (II) is no more than 10 g/L. According to some embodiments, the concentration of the carbon dioxide scavenger provided in step (II) is no more than 5 g/L. According to some embodiments, the concentration of the carbon dioxide scavenger provided in step (II) is no more than 2.5 g/L.

According to some embodiments, the concentration of the carbon dioxide scavenger in the mixture of step (III) is no more than 100 g/L. According to some embodiments, the concentration of the carbon dioxide scavenger in the mixture of step (III) is no more than 50 g/L.

According to some embodiments, the concentration of the carbon dioxide scavenger in the mixture of step (III) is no more than 25 g/L. According to some embodiments, the concentration of the carbon dioxide scavenger in the mixture of step (III) is no more than 10 g/L. According to some embodiments, the concentration of the carbon dioxide scavenger in the mixture of step (III) is no more than 5 g/L. According to some embodiments, the concentration of the carbon dioxide scavenger in the mixture of step (III) is no more than 2.5 g/L.

As further detailed herein, according to some embodiments, step (III) of the present method includes contacting the carbonated water provided in step (I) with the carbon dioxide scavenger provided in step (II), to form a solid water-insoluble scavenged carbon species and decarbonated water.

According to some embodiments, the chemical reaction of step (III) is a mono-phasic reaction.

Specifically, the term “mono-phasic reaction” refers to a reaction, where the reactants are in the same phase. Such reactions are much more rapid and easy to carry out, compared to biphasic reactions (e.g., liquid-gas reaction, liquid-(insoluble) solid reaction, and solid-gas reaction). The reaction of step (III) takes place in the liquid phase as the reactants are dissolved in water, according to some embodiments.

According to some embodiments, the scavenged carbon species is a compound which is formed from a reaction involving a CO₂ species, and which is processable into CO₂ gas and a CO₂ scavenger.

As detailed herein, the product of the reaction between the inorganic carbonated species and the carbon dioxide scavenger is a water-insoluble scavenged carbon species. Without wishing to be bound by any theory of mechanism of action, the product is preferable an insoluble solid, so that it is easy to separate from the decarbonated water in step (IV).

The term “water-insoluble” as used herein refers to a compound, which has aqueous solubility of 0.5 g/L or less at 25° C. and neutral pH.

According to some embodiments, the solid water-insoluble scavenged carbon species has aqueous solubility of no more than 100 mg/L at 25° C. According to some embodiments, the solid water-insoluble scavenged carbon species has aqueous solubility of no more than 500 mg/L at 25° C., no more than 300 mg/L at 25° C., no more than 200 mg/L at 25° C., no more than 100 mg/L at 25° C., no more than 75 mg/L at 25° C., no more than 50 mg/L at 25° C., no more than 33 mg/L at 25° C., no more than 25 mg/L at 25° C., no more than 20 mg/L at 25° C. or no more than 15 mg/L at 25° C. Each possibility represents a separate embodiment of the invention.

Specifically, the aqueous solubility of CaCO₃ is 13 mg/L at 25° C.

According to some embodiments, the solid water-insoluble scavenged carbon species is CaCO₃.

As detailed herein, according to some embodiments, the carbonated water includes an inorganic carbonated species, which may be a weak acid. Also, the carbon dioxide scavenger may be an inorganic base, which is reactable with the inorganic carbonated species, e.g., in a neutralization reaction. For example, according to some embodiments, the carbonated water comprises HCO₃″, and the carbon dioxide scavenger comprises Ca(OH)₂, which leads to the formation of CaCO₃.

According to some embodiments, the carbonated water comprises HCO₃″, and the carbon dioxide scavenger comprises Ca(OH)₂. According to some embodiments, the contacting of carbonated water with the Ca(OH)₂ in step (III) entails carrying out the chemical reaction:

HCO₃⁻+Ca(OH)₂→CaCO₃+H₂O+OH⁻;
thereby producing CaCO₃ as the solid water-insoluble scavenged carbon species, and decarbonated water. Specifically, as detailed above, CaCO₃ is only sparingly soluble, which leads to its precipitation and separation from the decarbonated water. Also, it is to be understood by a person having ordinary skill in the art that although water is a net reaction product of the reaction, the majority of decarbonated water originates from the carbonated water source, from which the HCO₃⁻ is removed during the above reaction, according to some embodiments.

According to some embodiments, the carbon dioxide scavenger comprises Ca(OH)₂. According to some embodiments, the contacting of carbonated water with the Ca(OH)₂ in step (III) entails carrying one or more of the chemical reactions:

CO₂+Ca(OH)₂→CaCO₃+H₂O;

H₂CO₃+Ca(OH)₂→CaCO₃+2H₂O;

HCO₃⁻+Ca(OH)₂→CaCO₃+H₂O+OH⁻;

CO₃⁻²+Ca(OH)₂→CaCO₃+2OH⁻;
thereby producing CaCO₃ as the solid water-insoluble scavenged carbon species, and decarbonated water. Each possible reaction represents a separate embodiment of the invention. According to some embodiments, the contacting of carbonated water with the Ca(OH)₂ in step (III) entails carrying two or more of the chemical reactions. According to some embodiments, the contacting of carbonated water with the Ca(OH)₂ in step (III) entails carrying three or more of the chemical reactions.

According to some embodiments, the contacting of carbonated water with the Ca(OH)₂ in step (III) entails carrying each of the above chemical reactions.

According to some embodiments, the ratio between the alkalinity of the carbonated water and the alkalinity of the decarbonated water is in the range of 0.5:1 to 2:1. According to some embodiments, the ratio between the alkalinity of the carbonated water and the alkalinity of the decarbonated water is in the range of 0.67:1 to 1.5:1. According to some embodiments, the ratio between the alkalinity of the carbonated water and the alkalinity of the decarbonated water is in the range of 0.75:1 to 1.33:1. According to some embodiments, the ratio between the alkalinity of the carbonated water and the alkalinity of the decarbonated water is in the range of 0.8:1 to 1.25:1. According to some embodiments, the ratio between the alkalinity of the carbonated water and the alkalinity of the decarbonated water is in the range of 0.9:1 to 1.1:1.

According to some embodiments, the alkalinity of the decarbonated water is substantially equal to the alkalinity of the carbonated water of step (I).

The term “Alkalinity” as used herein refers to a measurement of the ability of a solution to neutralize acids to the equivalence point of carbonate or bicarbonate. The alkalinity is equal to the stoichiometric sum of the bases in solution. Alkalinity is usually given in the unit mEq/L (milliequivalent per liter). Alternatively, alkalinity may also be given in the unit “ppm,” or parts per million.

Also, it is to be understood that the amount of the carbon dioxide scavenger (e.g., Ca(OH)₂) is determined by the pH of the carbonated water, DIC concentration, and the specific reaction stoichiometry.

According to some embodiments, the Ca(OH)₂: total inorganic carbonated species in the carbonated water ratio is in the range of 4:10 to 12:10 mol/mol, including each value and sub-range within the specified range. According to some embodiments, the Ca(OH)₂: total inorganic carbonated species in the carbonated water ratio is in the range of 5:10 to 10:10 mol/mol, including each value and sub-range within the specified range. According to some embodiments, the Ca(OH)₂: total inorganic carbonated species in the carbonated water ratio is in the range of 5:10 to 8:10 mol/mol, including each value and sub-range within the specified range. According to some embodiments, the Ca(OH)₂: total inorganic carbonated species in the carbonated water ratio is in the range of 8:10 to 9:10 mol/mol, including each value and sub-range within the specified range. According to some embodiments, the Ca(OH)₂: total inorganic carbonated species in the carbonated water ratio is in the range of 9:10 to 10:10 mol/mol, including each value and sub-range within the specified range.

According to some embodiments, the contacting thereof in step (III) entails contacting 0.25 to 4 moles of inorganic carbonated species per 1 mol of carbon dioxide scavenger. According to some embodiments, the contacting thereof in step (III) entails contacting 0.25 to 1.5, 0.33 to 1.25 or 0.5 to 1 moles of inorganic carbonated species per 1 mol of carbon dioxide scavenger. Each possibility represents a separate embodiment of the invention. According to some embodiments, the contacting thereof in step (III) entails contacting 0.75 to 4, 0.8 to 3 or 1 to 2 moles of inorganic carbonated species per 1 mol of carbon dioxide scavenger. Each possibility represents a separate embodiment of the invention.

According to some embodiments, the carbon dioxide scavenger is Ca⁺² salt, the carbonated water comprises inorganic carbonated species, and the contacting thereof in step (III) entails contacting 0.75 to 2.5 moles of inorganic carbonated species per 1 mol of Ca⁺². According to some embodiments, contacting thereof in step (III) entails contacting 1 to 2 moles of inorganic carbonated species per 1 mol of Ca⁺².

According to some embodiments, the carbon dioxide scavenger is Ca⁺² salt, the carbonated water comprises inorganic carbonated species, and the contacting thereof in step (III) entails contacting 0.5 to 2.5 moles of inorganic carbonated species per 1 mol of Ca⁺².

Although some embodiments of the present method relate to a batch reaction, it is to be understood that the present method may be carried out continuously.

According to some embodiments, the method comprises performing steps (I)-(III) continuously. According to some embodiments, the method comprises performing steps (I)-(III) repeatedly.

According to some embodiments, the contacting of the carbon dioxide scavenger with the inorganic carbonated species in step (III) entails contacting providing the carbon dioxide scavenger and the carbonated water continuously or in batches at a predetermined rate, so as to maintain a ratio of 0.75 to 2.5 moles of inorganic carbonated species per 1 mol of Ca⁺² in the mixture of step (III). According to some embodiments, the predetermined rate is determined so as to maintain a ratio of 1 to 2 moles of inorganic carbonated species per 1 mol of Ca⁺² in the mixture of step (III).

According to some embodiments, the contacting of the carbon dioxide scavenger with the inorganic carbonated species in step (III) entails contacting providing the carbon dioxide scavenger and the carbonated water continuously or in batches at a predetermined rate, so as to maintain a ratio of 0.5 to 2.5 moles of inorganic carbonated species per 1 mol of Ca⁺² in the mixture of step (III).

According to some embodiments, steps (I) and (II) entail continuously providing the inorganic carbonated species and the Ca⁺² salt at a relative rate of 0.75 to 2.5 moles of inorganic carbonated species per 1 mol of Ca⁺. According to some embodiments, steps (I) and (II) entail continuously providing the inorganic carbonated species and the Ca⁺² salt at a relative rate of 1 to 2 moles of inorganic carbonated species per 1 mol of Ca⁺.

According to some embodiments, steps (I) and (II) entail continuously providing the inorganic carbonated species and the Ca⁺² salt at a relative rate of 0.5 to 2.5 moles of inorganic carbonated species per 1 mol of Ca⁺.

Alongside the dissolved inorganic carbon (DIC) species, sea water also contains relatively high concentration of divalent ions, most prominently calcium (˜10 mM) and magnesium (˜50 mM). Interestingly, while the concentrations product of the calcium and carbonate ions exceeds the solubility product of calcium carbonate 3.3×10⁻⁹ M² [William M Haynes. CRC handbook of chemistry and physics. CRC press, 2014], precipitation is inhibited. This is explained by inhibition of nucleation by the presence of trace molecules in seawater [Elizabeth A Burton and Lynn M Walter. The role of pH in phosphate inhibition of calcite and aragonite precipitation rates in seawater. Geochimica et Cosmochimica Acta, 54 (3): 797-808, 1990], the effects of seawater ionic strength on the activities of calcium and carbonate [Pierpaolo Zuddas and Alfonso Mucci. Kinetics of calcite precipitation from seawater: Ii. the influence of the ionic strength. Geochimica et Cosmochimica Acta, 62 (5): 757-766, 1998] or both.

Thus, it is common that despite the insolubility of CaCO₃ its precipitation from aqueous compositions is often sluggish. One way of encountering this hurdle is to inducing its precipitation, e.g., through seeding small CaCO₃ crystals, over which dissolved CaCO₃ tend to precipitate more rapidly to form larger crystals or pellets, according to some embodiments.

According to some embodiments, forming a solid water-insoluble scavenged carbon species in step (III) comprises inducing precipitation of the water-insoluble scavenged carbon species from the water. According to some embodiments, forming a solid water-insoluble scavenged carbon species in step (III) comprises inducing precipitation of the water-insoluble scavenged carbon species from the water, through seeding seeds of the water-insoluble scavenged carbon species in the mixture of step (III).

According to some embodiments, the decarbonated water formed in step (III) is an aqueous solution. According to some embodiments, the decarbonated water formed in step (III) is an aqueous mixture. According to some embodiments, the decarbonated water formed in step (III) is an aqueous suspension.

According to some embodiments, the decarbonated water has inorganic carbonated species selected from the group consisting of: CO₂, H₂CO₃, HCO₃⁻ and a combination thereof, at a second concentration, wherein the first concentration is at least 1.1 times higher than the second concentration. According to some embodiments, the decarbonated water has inorganic carbonated species selected from the group consisting of: CO₂, H₂CO₃, HCO₃⁻ and a combination thereof, at a second concentration, wherein the first concentration is at least 1.15, at least 1.2, at least 1.33, at least 1.5, at least 2, at least 4, at least 6, at least 8, at least 10, at least 12, at least 14, at least 16, at least 18 or at least 20 times higher than the second concentration. Each possibility represents a separate embodiment of the invention.

According to some embodiments, the decarbonated water has total dissolved inorganic carbon (DIC) species at a second concentration, wherein the first concentration is at least 10 times higher than the second concentration. According to some embodiments, the decarbonated water has total dissolved inorganic carbon (DIC) species at a second concentration, wherein the first concentration is at least 1.1, at least 1.2, at least 1.33, at least 1.5, at least 2, at least 4, at least 6, at least 8, at least 12, at least 14, at least 16, at least 18 or at least 20 times higher than the second concentration. Each possibility represents a separate embodiment of the invention.

According to some embodiments, the second concentration is no more than 0.5 mM. According to some embodiments, the second concentration is no more than 2 mM, no more than 1.5 mM, no more than 1 mM, no more than 0.8 mM, no more than 0.6 mM, no more than 0.4 mM, no more than 0.3 mM, no more than 0.2 mM or no more than 0.1 mM. Each possibility represents a separate embodiment of the invention.

As detailed herein, the method of the present invention may be carried out using a carbon removal system 10, which is provided and elaborated herein.

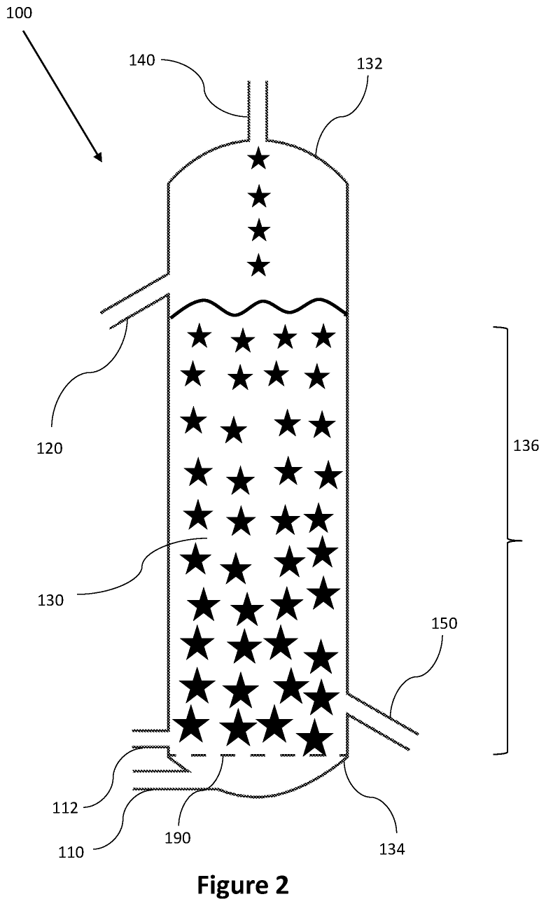

According to some embodiments, the carbon removal system comprises a pellet reactor 100. Reference is now made to FIG. 2, which shows the pellet reactor 100.

According to some embodiments, step (III) comprises contacting in the pellet reactor 100 the carbonated water with the carbon dioxide scavenger to form a solid water-insoluble scavenged carbon species and decarbonated water.

Generally, pellet reactors are typically cylindrical or conic vessels filled with seeding material. Water is pumped through the reactor in an upward direction at relatively high speeds to maintain the grains fluidized. In the bottom of the reactor, a reactant is dosed. As a result, a solid product becomes super-saturated and precipitates on the grains, which gradually turn into marble-like pellets, periodically removed from the reactor and replaced by new grains. Some of these pellets may then be reused as seeding material, according to some embodiments.

According to some embodiments, the pellet reactor 100 is a fluidized bed reactor.

The term “fluidized bed reactor” may be used to refer to reactors comprising a vessel that contains a granular solid material (e.g., seeding material, such as CaCO₃ grains), in which a fluid (e.g., a gas or a liquid, such as a carbonated aqueous solution) is passed through the granular solid material at velocities sufficiently high as to suspend the solid material and cause it to behave as though it were a fluid. The term “circulating fluidized bed reactor” may be used to refer to fluidized bed reactors in which the granular solid material is passed out of the reactor, circulated through a line in fluid communication with the reactor, and recycled back, at least partially, into the reactor.

According to some embodiments, the pellet reactor 100 comprises a first fluid inlet pipe 110. According to some embodiments, the pellet reactor 100 comprises a fluid outlet pipe 120. According to some embodiments, the pellet reactor 100 comprises an enclosed reaction chamber 130. According to some embodiments, the pellet reactor 100 comprises a second fluid inlet pipe 112.

According to some embodiments, the enclosed reaction chamber 130 comprises a top end 132 and a bottom end 134. The top end 132 and a bottom end 134 of the enclosed reaction chamber 130 are aligned with the corresponding top- and bottom ends of the pellet reactor 100, and are understood to the skilled in the art, upon witnessing any pellet reactor positioned on the ground or at sea. Specifically, the bottom end is positioned on the ground, on which the reactor is operating

According to some embodiments, the first fluid inlet pipe 110 is in fluid communication with the enclosed reaction chamber 130. According to some embodiments, the first fluid inlet pipe 110 is connected to the enclosed reaction chamber 130.

According to some embodiments, step (I) comprises providing the carbonated water from the natural or unnatural carbonated water source and into the enclosed reaction chamber 130 through the first fluid inlet pipe 110. According to some embodiments, step (I) comprises providing the carbonated water from the carbonated water source and in step (III) the carbonated water is inserted into the enclosed reaction chamber 130 through the first fluid inlet pipe 110. According to some embodiments, step (III) comprises inserting the carbonated water into the reaction chamber 130 through the first fluid inlet pipe 110, and wherein the contacting of the carbonated water with the carbon dioxide scavenger in step (III) is carried out within the reaction chamber 130.

According to some embodiments, the first fluid inlet pipe 110 comprises a valve (not shown) configured to monitor the liquid flow into the enclosed reaction chamber 130. According to some embodiments, the valve is configured to allow unidirectional flow of liquids into the enclosed reaction chamber 130.

According to some embodiments, step (I) comprises drawing the carbonated water from the natural or unnatural carbonated water source using a water pump (not shown). According to some embodiments, the water pump is an electric pump. According to some embodiments, the pump is in fluid communication with the first fluid inlet pipe 110. According to some embodiments, the water pump is configured to provide a pressurized stream of liquid into the enclosed reaction chamber 130.

According to some embodiments, the pellet reactor 100 further comprises a semi-permeable filter (not shown), which is permeable to water but impermeable to solids above a predetermined diameter. According to some embodiments, the predetermined diameter is in the range of 1 micron to 3 mm, 10 micron to 3 mm or 50 micron to 3 mm. Each possibility represents a separate embodiment of the invention. According to some embodiments, the semi-permeable filter has a cutoff is in the range of 0.15 to 0.5 millimeters. According to some embodiments, the semi-permeable filter has a cutoff is in the range of 0.07 to 0.16 millimeters.

According to some embodiments, the semi-permeable filter is positioned to separate between the reaction chamber 130 and the first fluid inlet pipe 110. According to some embodiments, the provision of the carbonated water into the enclosed reaction chamber 130 through the first fluid inlet pipe 110 further comprises filtering the carbonated water from solids present in the carbonated water source, by flowing the carbonated water through the semi-permeable filter, and flowing the filtered carbonated water through the first fluid inlet pipe 110.

According to some embodiments, the second fluid inlet pipe 112 is in fluid communication with the enclosed reaction chamber 130. According to some embodiments, the second fluid inlet pipe 112 is connected to the enclosed reaction chamber 130.

According to some embodiments, step (II) comprises providing the carbon dioxide scavenger as a fluid composition into the enclosed reaction chamber 130 through the second fluid inlet pipe 112. According to some embodiments, the fluid composition is an aqueous Ca(OH)₂ composition.

According to some embodiments, the second fluid inlet pipe 112 comprises a valve (not shown) configured to monitor the liquid flow into the enclosed reaction chamber 130. According to some embodiments, the valve is configured to allow unidirectional flow of liquids into the enclosed reaction chamber 130.

According to some embodiments, a semi-permeable filter is positioned to separate between the reaction chamber 130 and the second fluid inlet pipe 112. According to some embodiments, the provision of the carbon dioxide scavenger into the enclosed reaction chamber 130 through the second fluid inlet pipe 112 further comprises filtering the fluid composition from solids present therein, by flowing the fluid composition through the semi-permeable filter.

Typically, pressurized gas or liquid enters the fluidized bed vessel through numerous holes via a plate known as a distributor plate, located at the bottom of the fluidized bed. The fluid flows upward through the bed, causing the solid particles to be suspended. If the inlet fluid is disabled, the bed may settle, pack onto the plate or trickle down through the plate. Many industrial beds use a sparger distributor instead of a distributor plate. The fluid is then distributed through a series of perforated tubes.

According to some embodiments, the pellet reactor 100 further comprises a distributor plate 190. According to some embodiments, the distributor plate 190 is configured to increase the flow of the carbonated water into the enclosed reaction chamber 130. According to some embodiments, the distributor plate 190 is configured to increase the flow of the carbonated water into the enclosed reaction chamber 130, so as to create a fluidized environment there within.

According to some embodiments, the distributor plate 190 is located in the vicinity of the enclosed reaction chamber bottom end 134. According to some embodiments, the first fluid inlet pipe 110 is located in the vicinity of the enclosed reaction chamber bottom end 134. According to some embodiments, the distributor plate 190 is located between the connection of the first fluid inlet pipe 110 to the pellet reactor 100 and the enclosed reaction chamber top end 132. According to some embodiments, the second fluid inlet pipe 112 is located in the vicinity of the enclosed reaction chamber bottom end 134. According to some embodiments, the connection of second fluid inlet pipe 112 to the enclosed reaction chamber 130 is located between the distributor plate 190 and the enclosed reaction chamber top end 132. According to some embodiments, the distributor plate 190 is located between the connection of second fluid inlet pipe 112 to the enclosed reaction chamber 130 and the connection of first fluid inlet pipe 110 to the enclosed reaction chamber 130.

According to some embodiments, the carbon dioxide scavenger is provided in step (II) as an aqueous composition. According to some embodiments, step (II) comprises providing an aqueous mixture of the carbon dioxide scavenger.

According to some embodiments, step (II) comprises providing an aqueous mixture of the carbon dioxide scavenger through the first fluid inlet pipe 110.

According to some embodiments, the method comprises pre-mixing the carbonated water and the carbon dioxide scavenger to form an aqueous mixture, which is reacted in step (III).

According to some embodiments, step (III) comprises mixing the carbonated water provided in step (I) and the carbon dioxide scavenger provided in step (II), and flowing the mixture through the first fluid inlet pipe 110 into the enclosed reaction chamber 130. According to some embodiments, step (III) comprises dissolving the carbon dioxide scavenger in the carbonated water and inserting the formed solution into the reaction chamber 130 through the first fluid inlet pipe 110.

According to some embodiments, the fluid outlet pipe 120 is in fluid communication with the reaction chamber 130. According to some embodiments, the fluid outlet pipe 120 is connected to the reaction chamber 130. According to some embodiments, each of the first fluid inlet pipe 110 and the fluid outlet pipe 120 is in fluid communication with the reaction chamber 130.

According to some embodiments, the fluid outlet pipe 120 comprises a valve (not shown) configured to monitor the liquid flow out of the enclosed reaction chamber 130. According to some embodiments, the valve is configured to allow unidirectional flow of liquids away from the enclosed reaction chamber 130.

According to some embodiments, the fluid outlet pipe 120 comprises a standard filter (not shown) which is permeable to water but impermeable to solids above a predetermined diameter, and prevents small seeds of scavenged carbon species to leave the reaction chamber 130 through the fluid outlet pipe 120.

According to some embodiments, step (III) further comprises evacuating the decarbonated water through the fluid outlet pipe 120. According to some embodiments, step (III) further comprises evacuating the decarbonated water from the enclosed reaction chamber 130 through the fluid outlet pipe 120.

As further detailed above, step (IV) comprises isolating the scavenged carbon species from the decarbonated water.

As can be understood by a person having ordinary skill in the art during step (III), the contents of the enclosed reaction chamber 130 include liquids (e.g., the carbonated water and the decarbonated water, and their solutes) and solids (e.g., the formed solid water-insoluble scavenged carbon species, seeds of the same material, and other precipitates). In order to bring the decarbonated water back into the water source (e.g., the ocean), it should be separated from these CO₂-containing solids, otherwise carbon will be returned to the water source. Due to the simple and environmentally friendly nature of the present method, the solid may simply be filtered from the liquid using a standard filter which is permeable to water but impermeable to solids above a predetermined diameter, so that decarbonated water are brought back to the water source.

According to some embodiments, the pellet reactor 100 further comprises a semi-permeable filter (not shown), which is permeable to water but impermeable to solids above a predetermined diameter. According to some embodiments, the semi-permeable filter is positioned to separate between the reaction chamber 130 and the fluid outlet pipe 120. According to some embodiments, the evacuation of the decarbonated water of step (III) further comprises filtering the decarbonated water from the scavenged carbon species by flowing the decarbonated water through the semi-permeable filter, and flowing the filtered decarbonated water through the fluid outlet pipe 120.

According to some embodiments, the method further comprising transferring the decarbonated water formed in step (III) into the carbonated water source.

According to some embodiments, step (IV) further comprises transferring the decarbonated water to the carbonated water source.

Specifically, in contrast with other carbon dioxide removal approaches, the reactions performed inside the enclosed reaction chamber 130 substantially preserve the alkalinity of the carbonated water, so that the product decarbonated water may be returned to the ocean to complete an environmentally friendly cycle where it reabsorbs carbon dioxide from the air and becomes chemically similar to the carbonated water initially fed into the pellet reactor 100, according to some embodiments.

According to some embodiments, the fluid outlet pipe 120 is located in the vicinity of the enclosed reaction chamber top end 132.

Specifically, it is preferable according to some embodiments, that the enclosed reaction chamber 130 is an elongated structure, wherein the first fluid inlet pipe 110 is located in the vicinity of its bottom end 134 and the fluid outlet pipe 120 is located in the vicinity of its top end 132. Without wishing to be bound by any theory of mechanism of action, this structure allows to induce flow of the pressurized reactants provided in steps (I) and (II) from the bottom end 132 to the top end 134 of the enclosed reaction chamber 130. This results in high concentration of the product decarbonated water in the vicinity of the enclosed reaction chamber top end 132, where it is evacuated, according to some embodiments. The bottom to top configurational considerations are further elaborated below, when discussing the seeding and solid system (e.g., the solid inlet pipe 140 and the solid outlet pipe 150).

Thus, according to some embodiments, the fluid outlet pipe 120 is connected to the reaction chamber 130 in the vicinity of its top end 132, and the first fluid inlet pipe 110 is connected to the reaction chamber 130 in the vicinity of its bottom end 134.

According to some embodiments, the pellet reactor further comprises a solid outlet pipe 150. According to some embodiments, step (IV) comprises evacuating the scavenged carbon species through the solid outlet pipe 150. According to some embodiments, step (IV) comprises evacuating the scavenged carbon species through the solid outlet pipe 150, thereby isolating the scavenged carbon species from the decarbonated water. According to some embodiments, step (IV) comprises evacuating an aqueous mixture comprising the scavenged carbon species through the solid outlet pipe 150, and then separating the scavenged carbon species from the water in the aqueous mixture.

According to some embodiments, the solid outlet pipe 150 comprises a valve (not shown) configured to monitor the solid flow out of the enclosed reaction chamber 130. According to some embodiments, the valve is configured to allow unidirectional flow of solid away from the enclosed reaction chamber 130.

As detailed above, a mixture of solids and liquid may be present inside the enclosed reaction chamber 130, according to some embodiments. However, the solids and liquid may be easily separated. For example, the reaction chamber 130 can be drained from liquid through the filter and fluid outlet pipe 120 to keep mostly water-insoluble scavenged carbon species (e.g., CaCO₃) in the chamber 130, and then evacuating the chamber 130 from the solids through the solid outlet 150. Thus, according to some embodiments, the present method comprises first evacuating the decarbonated water from the enclosed reaction chamber 130 and then evacuating the solid water-insoluble scavenged carbon species therefrom.

It is to be understood by the person having ordinary skill in the art that typically solids precipitate into the bottom of a reaction vessel after a reaction, and thus they may be preferably evacuated from the bottom of the vessel. Thus, according to some embodiments, in order to achieve efficient separation of the solid water-insoluble scavenged carbon species from the decarbonated water, the solid outlet pipe 150 is preferably located in the vicinity of the enclosed reaction chamber bottom end 134, above the distributor plate 190, according to some embodiments.

According to some embodiments, the solid outlet pipe 150 is connected to the reaction chamber 130 in the vicinity of its bottom end 134.

According to some embodiments, the pellet reactor 100 further comprises a solid inlet pipe 140. According to some embodiments, step (III) further comprises inserting seeds of the scavenged carbon species into the reaction chamber 130 through the solid inlet pipe 140. Some advantages of the seeding step are detailed above.

According to some embodiments, the solid inlet pipe 140 comprises a valve (not shown) configured to monitor the solid flow into the enclosed reaction chamber 130. According to some embodiments, the valve is configured to allow unidirectional flow of solids into the enclosed reaction chamber 130.

According to some embodiments, step (III) further comprises fluidizing the seeds in the reaction chamber 130.

According to some embodiments, step (III) further comprises fluidizing the seeds in the reaction chamber 130, thereby inducing precipitation of the scavenged carbon species formed from a chemical reaction between the CO₂ species and the CO₂ scavenger.

According to some embodiments, forming CaCO₃ in step (III) comprises inducing precipitation of the CaCO₃ from the water, through seeding seeds of CaCO₃ in the mixture of step (III).

According to some embodiments, the seeds of CaCO₃ have an average particle size in the range of between 0.16 to 1 millimeter. According to some embodiments, the seeds of CaCO₃ have an average particle size in the range of 0.07 to 0.160 millimeters. According to some embodiments, the seeds of CaCO₃ have an average particle size in the range of 0.077 to 0.094 millimeters. According to some embodiments, the seeds of CaCO₃ have an average particle size in the range of 0.094 to 0.109 millimeters. According to some embodiments, the seeds of CaCO₃ have an average particle size in the range of 0.109 to 0.122 millimeters. According to some embodiments, the seeds of CaCO₃ have an average particle size in the range of 0.122 to 0.133 millimeters. According to some embodiments, the seeds of CaCO₃ have an average particle size in the range of 0.133 to 0.144 millimeters. According to some embodiments, the seeds of CaCO₃ have an average particle size in the range of 0.144 to 0.154 millimeters. According to some embodiments, the seeds of CaCO₃ have a particle size in the range of 0.07 to 0.160 millimeters. According to some embodiments, the seeds of CaCO₃ have a particle size in the range of 0.077 to 0.094 millimeters. According to some embodiments, the seeds of CaCO₃ have a particle size in the range of 0.094 to 0.109 millimeters. According to some embodiments, the seeds of CaCO₃ have a particle size in the range of 0.109 to 0.122 millimeters. According to some embodiments, the seeds of CaCO₃ have a particle size in the range of 0.122 to 0.133 millimeters. According to some embodiments, the seeds of CaCO₃ have a particle size in the range of 0.133 to 0.144 millimeters. According to some embodiments, the seeds of CaCO₃ have a particle size in the range of 0.144 to 0.154 millimeters.

According to some embodiments, step (III) further comprises allowing maturation of pellets of the precipitated CaCO₃. According to some embodiments, step (III) further comprises allowing maturation of pellets of the precipitated CaCO₃, to a pellet size in the range of 0.15 to 1.5 millimeters. According to some embodiments, step (III) further comprises allowing maturation of pellets of the precipitated CaCO₃, to a pellet size in the range of 0.5 to 1.5 millimeters. According to some embodiments, step (III) further comprises allowing maturation of pellets of the precipitated CaCO₃, to a pellet size in the range of 0.15 to 0.5 millimeters. According to some embodiments, the pellet size is in the range of 0.183 to 0.240 millimeters. According to some embodiments, the pellet size is in the range of 0.240 to 0.291 millimeters. According to some embodiments, the pellet size is in the range of 0.291 to 0.338 millimeters. According to some embodiments, the pellet size is in the range of 0.338 to 0.381 millimeters.

According to some embodiments, the pellet size is in the range of 0.381 to 0.423 millimeters. According to some embodiments, the pellet size is in the range of 0.423 to 0.462 millimeters. According to some embodiments, step (III) further comprises allowing maturation of pellets of the precipitated CaCO₃, to a pellet size in the range of 0.15 to 0.5 millimeters. According to some embodiments, the pellets have an average pellet size in the range of 0.183 to 0.240 millimeters. According to some embodiments, the pellets have an average pellet size in the range of 0.240 to 0.291 millimeters. According to some embodiments, the pellets have an average pellet size in the range of 0.291 to 0.338 millimeters. According to some embodiments, the pellets have an average pellet size in the range of 0.338 to 0.381 millimeters. According to some embodiments, the pellets have an average pellet size in the range of 0.381 to 0.423 millimeters. According to some embodiments, the pellets have an average pellet size in the range of 0.423 to 0.462 millimeters. According to some embodiments, step (IV) comprises isolating the precipitated CaCO₃ pellets, matured to said pellet size.

According to some embodiments, step (III) further comprises allowing maturation of pellets of the precipitated CaCO₃, to a pellet size in the range of 0.15 to 0.5 millimeters, wherein the step (IV) comprises isolating the precipitated CaCO₃ pellets, matured to said pellet size.

According to some embodiments, the seeds of CaCO₃ have an average particle size, wherein step (III) further comprises allowing maturation of pellets of precipitated CaCO₃, to a pellet size, wherein the step (IV) comprises isolating the precipitated CaCO₃ pellets, matured to said pellet size.

According to some embodiments, the particle size of the matured CaCO₃ pellets is at least 25% greater than the particle size of the seeds of CaCO₃. According to some embodiments, the particle size of the matured CaCO₃ pellets is at least 50% greater than the particle size of the seeds of CaCO₃. According to some embodiments, the particle size of the matured CaCO₃ pellets is at least 100% greater than the particle size of the seeds of CaCO₃. According to some embodiments, the particle size of the matured CaCO₃ pellets is at least 150% greater than the particle size of the seeds of CaCO₃. According to some embodiments, the particle size of the matured CaCO₃ pellets is at least 200% greater than the particle size of the seeds of CaCO₃. According to some embodiments, the particle size of the matured CaCO₃ pellets is at least 300% greater than the particle size of the seeds of CaCO₃. According to some embodiments, the particle size of the matured CaCO₃ pellets is at least 400% greater than the particle size of the seeds of CaCO₃. According to some embodiments, the particle size of the matured CaCO₃ pellets is at least 500% greater than the particle size of the seeds of CaCO₃. According to some embodiments, the particle size of the matured CaCO₃ pellets is at least 750% greater than the particle size of the seeds of CaCO₃.

According to some embodiments, the particle size of the matured CaCO₃ pellets is at least 100% greater than the particle size of the seeds of CaCO₃.

According to some embodiments, the seeds of CaCO₃ have an average particle size, wherein step (III) further comprises allowing maturation of pellets of precipitated CaCO₃, to a pellet size, wherein the step (IV) comprises isolating the precipitated CaCO₃ pellets, matured to said pellet size, and wherein the particle size of the matured CaCO₃ pellets is at least 100% greater than the particle size of the seeds of CaCO₃.

The pellet reactor 100 may be a cylindrical fluidized bed reactor having elongated structure, according to some embodiments. According to some embodiments, the pellet reactor 100 may be with or without a conical shaped base. As detailed above, a solution of carbonated water (e.g., from seawater) and carbon dioxide scavenger (e.g., Ca(OH)₂) may be fed into the lower part of the reaction chamber 130. Also, nucleation seeds of the scavenged CO₂ species (e.g., CaCO₃ seeds) may be added to the enclosed reaction chamber 130 from its top 132, according to some embodiments. The bottom-to-top pressurize stream of the reactant mixture results in fluidizing the nucleation seeds in the enclosed reaction chamber 130, according to some embodiments. This fluidization results in rapid precipitation of scavenged CO₂ species over the nucleation seed, to form pellets of the scavenged CO₂ in the pellet reactor 100. According to some embodiments, the carbon dioxide scavenger is Ca(OH)₂ which dissolves in the carbonated water, and subsequently increasing the concentration of calcium ions and the pH, which in turn promotes deprotonation of bicarbonate ions to carbonate ions. Then, the increase of the pH and concentration of calcium ions increases the concentration product of the calcium and carbonate ions and promotes precipitation of CaCO₃. This is further promoted by the nucleation seeds, which provide surface area for the precipitation reaction to occur, and grow in their diameter as it proceeds. Following precipitation of CaCO₃, the concentration of inorganic carbon in the mixture within the reaction chamber 130 decreases as it flows toward the upper end 132 thereof, according to some embodiments. At the top of the enclosed reaction chamber 130 decarbonated water is discharged through the fluid outlet pipe 120 and may be returned to the ocean, according to some embodiments. At the same time, due to the increase in the size of the crystals (of solid water-insoluble scavenged carbon species), they become heavier and gradually sink to lower parts of the enclosed reaction chamber 130. Eventually, the largest seeds reach the bottom of the reactor where they are discharged through the solid outlet pipe 150. As further detailed below, these crystals or pellets, may then be fed into the calciner 200 for further processing, according to some embodiments. To maintain the number of CaCO₃ seeds within the enclosed reaction chamber 130 constant, new seeds may be periodically added to its top end 132, through the solid inlet pipe 140, to compensate for the ones that are discharged as pellets, according to some embodiments. The new seeds may be obtained from crushing large pellets and/or CaCO₃ from any one of the steps of the present method.

According to some embodiments, the solid water-insoluble scavenged carbon species seeds include crystals having a first average diameter. According to some embodiments, the solid water-insoluble scavenged carbon species formed in step (III) includes pellets having a second average diameter. According to some embodiments, the CaCO₃ seeds include crystals having a first average diameter. According to some embodiments, the CaCO₃ formed in step (III) includes pellets having a second average diameter.

The differences in diameter are indicated in FIG. 2, which shows the scavenged inorganic carbon species pellets formed in the reaction of step (III) as large stars, which sink towards the bottom end 134 of the reaction chamber 130, and the seeds inserted at the top end 132 of the reaction chamber 130 through the solid inlet pipe 140, as smaller stars, which are fluidized.

According to some embodiments, the second diameter is at least 50%, at least 100%, at least 200%, at least 500%, or at least 1000% larger than the first diameter.

According to some embodiments, the solid inlet pipe 140 is connected to the reaction chamber 130 in the vicinity of its top end 132.

According to some embodiments, the fluidized bed pellet reactor 100 comprises: a first fluid inlet pipe 110, a second fluid inlet pipe 112, a solid inlet pipe 140, a fluid outlet pipe 120, a solid outlet pipe 150 and an enclosed reaction chamber 130, which comprises a top end 132 and a bottom end 134, wherein each of the solid inlet pipe 140 and the fluid outlet pipe 120 is connected to the reaction chamber 130 in the vicinity of its top end 132, and each of the solid outlet pipe 150, the first fluid inlet pipe 110 and the second fluid inlet pipe 112 is connected to the reaction chamber 130 in the vicinity of its bottom end 134; wherein the carbonated water comprises at least HCO₃″, and the carbon dioxide scavenger comprises Ca(OH)₂;
step (III) comprises: inserting the carbonated water into the reaction chamber 130 through the first fluid inlet pipe 110; preparing an aqueous composition of the Ca(OH)₂ in water and inserting the formed composition into the reaction chamber 130 through the second fluid inlet pipe 112; inserting CaCO₃ seeds into the reaction chamber 130 through the solid inlet pipe 140 in the vicinity of the reaction chamber top end 132 and fluidizing said seeds, thereby inducing precipitation of CaCO₃ formed from a chemical reaction between the HCO₃⁻ and the Ca(OH)₂, so that the formed CaCO₃ is sinking to the bottom end 134 of the reaction chamber 130 and the decarbonated water flows to the vicinity of the top end 132 of the reaction chamber 130; and evacuating the decarbonated water from the top end 132 of the reaction chamber 130 through the fluid outlet pipe 120; and
step (IV) comprises evacuating the CaCO₃ from the bottom end 134 of the reaction chamber 130 through the solid outlet pipe 150.

According to some embodiments, the fluidized bed pellet reactor 100 comprises: a first fluid inlet pipe 110, a solid inlet pipe 140, a fluid outlet pipe 120, a solid outlet pipe 150 and an enclosed reaction chamber 130, which comprises a top end 132 and a bottom end 134, wherein each of the solid inlet pipe 140 and the fluid outlet pipe 120 is connected to the reaction chamber 130 in the vicinity of its top end 132, and each of the solid outlet pipe 150 and the first fluid inlet pipe 110 is connected to the reaction chamber 130 in the vicinity of its bottom end 134; wherein the carbonated water comprises at least HCO₃″, and the carbon dioxide scavenger comprises Ca(OH)₂;
step (III) comprises: dissolving the Ca(OH)₂ in the carbonated water and inserting the formed solution into the reaction chamber 130 through the first fluid inlet pipe 110; inserting CaCO₃ seeds into the reaction chamber 130 through the solid inlet pipe 140 in the vicinity of the reaction chamber top end 132 and fluidizing said seeds, thereby inducing precipitation of CaCO₃ formed from a chemical reaction between the HCO₃⁻ and the Ca(OH)₂, so that the formed CaCO₃ is sinking to the bottom end 134 of the reaction chamber 130 and the decarbonated water flows to the vicinity of the top end 132 of the reaction chamber 130; and evacuating the decarbonated water from the top end 132 of the reaction chamber 130 through the fluid outlet pipe 120; and
step (IV) comprises evacuating the CaCO₃ from the bottom end 134 of the reaction chamber 130 through the solid outlet pipe 150.

It is to be understood that the steps of the present method may occur alternately or simultaneously in a flow-type process.

According to some embodiments, fluidizing said seeds in step (III) entails providing a pressurized stream of the carbonated water and carbon dioxide scavenger through the distributor plate 190 in the direction from the enclosed reaction chamber bottom end 134 to the enclosed reaction chamber top end 132.

According to some embodiments, step (III) further comprises inserting seeds of the solid water-insoluble scavenged carbon species into the reaction chamber 130 through the solid inlet pipe 140 and fluidizing the seeds in the reaction chamber 130 to a fluidized grains height 136, thereby inducing precipitation and maturation of solid water-insoluble scavenged carbon species pellets. According to some embodiments, the carbon dioxide scavenger is Ca(OH)₂, wherein the fluidized bed pellet reactor 100 further comprises a solid inlet pipe 140, wherein step (III) further comprises inserting seeds of the CaCO₃ into the reaction chamber 130 through the solid inlet pipe 140 and fluidizing the seeds in the reaction chamber to a fluidized grains height, thereby inducing precipitation and maturation of CaCO₃ pellets.

The term “fluidized grains height”, which is commonly referred as “fluidized bed height”, as used herein refers to the distance between the bottom pellets (positioned on the distributor plate 190) and the most elevated fluidized seeds, as portrayed in FIG. 2, element 136.

According to some embodiments, the fluidized grains height 136 is in the range of 0.6 meter to 12.4 meter, including each value and sub-range within the specified range.

According to some embodiments, the fluidized grains height 136 is in the range of 0.2 meter to 12.4 meter, including each value and sub-range within the specified range. According to some embodiments, the fluidized grains height 136 is in the range of 0.5 meter to 5 meter. According to some embodiments, the fluidized grains height 136 is in the range of 1.1 meter to 2.4 meter. According to some embodiments, the fluidized grains height 136 is in the range of 0.6 meter to 1.3 meter. According to some embodiments, the fluidized grains height 136 is in the range of 0.3 meter to 0.7 meter. According to some embodiments, the fluidized grains height 136 is in the range of 0.2 meter to 0.4 meter. According to some embodiments, the fluidized grains height 136 is in the range of 2.2 meter to 3.9 meter. According to some embodiments, the fluidized grains height 136 is in the range of 1.2 meter to 2.1 meter. According to some embodiments, the fluidized grains height 136 is in the range of 0.6 meter to 1.1 meter. According to some embodiments, the fluidized grains height 136 is in the range of 0.3 meter to 0.6 meter. According to some embodiments, the fluidized grains height 136 is in the range of 3.6 meter to 5.6 meter. According to some embodiments, the fluidized grains height 136 is in the range of 1.9 meter to 3 meter. According to some embodiments, the fluidized grains height 136 is in the range of 1 meter to 1.6 meter. According to some embodiments, the fluidized grains height 136 is in the range of 0.5 meter to 0.8 meter. According to some embodiments, the fluidized grains height 136 is in the range of 5.2 meter to 7.6 meter. According to some embodiments, the fluidized grains height 136 is in the range of 2.8 meter to 4.1 meter. According to some embodiments, the fluidized grains height 136 is in the range of 1.5 meter to 2.2 meter. According to some embodiments, the fluidized grains height 136 is in the range of 0.8 meter to 1.1 meter. According to some embodiments, the fluidized grains height 136 is in the range of 7.2 meter to 9.9 meter. According to some embodiments, the fluidized grains height 136 is in the range of 3.8 meter to 5.3 meter. According to some embodiments, the fluidized grains height 136 is in the range of 2.1 meter to 2.8 meter. According to some embodiments, the fluidized grains height 136 is in the range of 1 meter to 1.4 meter. According to some embodiments, the fluidized grains height 136 is in the range of 9.3 meter to 12.4 meter. According to some embodiments, the fluidized grains height 136 is in the range of 4.9 meter to 6.6 meter. According to some embodiments, the fluidized grains height 136 is in the range of 2.6 meter to 3.5 meter. According to some embodiments, the fluidized grains height 136 is in the range of 1.3 meter to 1.8 meter.

According to some embodiments, step (III) further comprises inserting seeds of CaCO₃ into the reaction chamber through the solid inlet pipe 140 and fluidizing the seeds in the reaction chamber 130, thereby inducing precipitation and maturation of CaCO₃ pellets.

According to some embodiments, step (III) comprises inserting the carbonated water into the reaction chamber 130 through the first fluid inlet pipe 110 at a first superficial velocity. The term “superficial velocity” as used herein refers to the volumetric flow rate of the liquid, divided by the cross-sectional available area of the reaction chamber 130 per unit of time, when the liquid flows upwards, expressed in meters per hour (m/h).

Also, a residence time of the water within the fluidized bed reactor may be calculated based on the by the reactor height and the superficial velocity. Advantageously, it was found that the residence time required for the fluid inside the reactor is of the order of a few minutes for removal of more than 50% of the DIC. That is a more than two orders of magnitude improvements compared to conventional precipitation tanks.

Thus, according to some embodiments, the step (III) comprises flowing the carbonated water into the reaction chamber 130 through the first fluid inlet pipe 110, and out of the reaction chamber 130 through the fluid outlet pipe 120, so that the water resides within the reaction chamber 130 for a predetermined residence time. According to some embodiments, the residence time is in the range of 10 seconds to 1 hour, including each value and sub-range within the specified range. According to some embodiments, the residence time is in the range of 1 minute to 20 minutes. According to some embodiments, the residence time is in the range of 1 minute to 10 minutes. According to some embodiments, the residence time is in the range of 1 minute to 5 minutes.

According to some embodiments, the particle size of the seeds of CaCO₃ is in the range of 0.077-0.094 millimeters, the particle size of the precipitated CaCO₃ pellets is in the range of 0.183-0.240 millimeters, the first superficial velocity is in the range of 20 to 30 meters per hour, the fluidized grains height in the range of 1.1-2.4 meters and the Ca(OH)₂: total inorganic carbonated species in the carbonated water ratio is in the range of 9:10 to 10:10 mol/mol. According to some embodiments, the application of the present method using these parameters results in dissolved inorganic carbon removal in the range of 90% to 100%. According to some embodiments, this rate of dissolved inorganic carbon removal is achieved by flowing the water within the fluidized bed reactor for a residence time in the range of 1 minute to 20 minutes, 1 minute to 10 minutes or 1 minute to 5 minutes.

It is to be understood that inorganic carbon removal in the range of 90% to 100% means that 90% to 100% of the inorganic carbonated species in the carbonated water provided in step (a) are removed through the method, so that the product decarbonated water includes no more than 10% of said inorganic carbonated species.

According to some embodiments, the particle size of the seeds of CaCO₃ is in the range of 0.077-0.094 millimeters, the particle size of the precipitated CaCO₃ pellets is in the range of 0.183-0.240 millimeters, the first superficial velocity is in the range of 20 to 30 meters per hour, the fluidized grains height in the range of 0.6-1.3 meters and the Ca(OH)₂: total inorganic carbonated species in the carbonated water ratio is in the range of 8:10 to 9:10 mol/mol. According to some embodiments, the application of the present method using these parameters results in dissolved inorganic carbon removal in the range of 80% to 90%. According to some embodiments, this rate of dissolved inorganic carbon removal is achieved by flowing the water within the fluidized bed reactor for a residence time in the range of 1 minute to 20 minutes, 1 minute to 10 minutes or 1 minute to 5 minutes.

According to some embodiments, the particle size of the seeds of CaCO₃ is in the range of 0.077-0.094 millimeters, the particle size of the precipitated CaCO₃ pellets is in the range of 0.183-0.240 millimeters, the first superficial velocity is in the range of 20 to 30 meters per hour, the fluidized grains height in the range of 0.3-0.7 meters and the Ca(OH)₂: total inorganic carbonated species in the carbonated water ratio is in the range of 5:10 to 8:10 mol/mol. According to some embodiments, the application of the present method using these parameters results in dissolved inorganic carbon removal in the range of 50% to 80%. According to some embodiments, this rate of dissolved inorganic carbon removal is achieved by flowing the water within the fluidized bed reactor for a residence time in the range of 1 minute to 20 minutes, 1 minute to 10 minutes or 1 minute to 5 minutes.

According to some embodiments, the particle size of the seeds of CaCO₃ is in the range of 0.094-0.109 millimeters, the particle size of the precipitated CaCO₃ pellets is in the range of 0.240-0.291 millimeters, the first superficial velocity is in the range of 30 to 40 meters per hour, the fluidized grains height in the range of 2.2-3.9 meters and Ca(OH)₂: total inorganic carbonated species in the carbonated water ratio is in the range of 9:10 to 10:10 mol/mol. According to some embodiments, the application of the present method using these parameters results in dissolved inorganic carbon removal in the range of 90% to 100%. According to some embodiments, this rate of dissolved inorganic carbon removal is achieved by flowing the water within the fluidized bed reactor for a residence time in the range of 1 minute to 20 minutes, 1 minute to 10 minutes or 1 minute to 5 minutes.

According to some embodiments, the particle size of the seeds of CaCO₃ is in the range of 0.094-0.109 millimeters, the particle size of the precipitated CaCO₃ pellets is in the range of 0.240-0.291 millimeters, the first superficial velocity is in the range of 30 to 40 meters per hour, the fluidized grains height in the range of 1.2-2.1 meters and the Ca(OH)₂: total inorganic carbonated species in the carbonated water ratio is in the range of 8:10 to 9:10 mol/mol. According to some embodiments, the application of the present method using these parameters results in dissolved inorganic carbon removal in the range of 80% to 90%. According to some embodiments, this rate of dissolved inorganic carbon removal is achieved by flowing the water within the fluidized bed reactor for a residence time in the range of 1 minute to 20 minutes, 1 minute to 10 minutes or 1 minute to 5 minutes.

According to some embodiments, the particle size of the seeds of CaCO₃ is in the range of 0.094-0.109 millimeters, the particle size of the precipitated CaCO₃ pellets is in the range of 0.240-0.291 millimeters, the first superficial velocity is in the range of 30 to 40 meters per hour, the fluidized grains height in the range of 0.6-1.1 meters and the Ca(OH)₂: total inorganic carbonated species in the carbonated water ratio is in the range of 5:10 to 8:10 mol/mol. According to some embodiments, the application of the present method using these parameters results in dissolved inorganic carbon removal in the range of 50% to 80%. According to some embodiments, this rate of dissolved inorganic carbon removal is achieved by flowing the water within the fluidized bed reactor for a residence time in the range of 1 minute to 20 minutes, 1 minute to 10 minutes or 1 minute to 5 minutes.

According to some embodiments, the particle size of the seeds of CaCO₃ is in the range of 0.109-0.122 millimeters, the particle size of the precipitated CaCO₃ pellets is in the range of 0.291-0.338 millimeters, the first superficial velocity is in the range of 40 to 50 meters per hour, the fluidized grains height in the range of 3.6-5.6 meters and the Ca(OH)₂: total inorganic carbonated species in the carbonated water ratio is in the range of 9:10 to 10:10 mol/mol. According to some embodiments, the application of the present method using these parameters results in dissolved inorganic carbon removal in the range of 90% to 100%. According to some embodiments, this rate of dissolved inorganic carbon removal is achieved by flowing the water within the fluidized bed reactor for a residence time in the range of 1 minute to 20 minutes, 1 minute to 10 minutes or 1 minute to 5 minutes.

According to some embodiments, the particle size of the seeds of CaCO₃ is in the range of 0.109-0.122 millimeters, the particle size of the precipitated CaCO₃ pellets is in the range of 0.291-0.338 millimeters, the first superficial velocity is in the range of 40 to 50 meters per hour, the fluidized grains height in the range of 1.9-3 meters and the Ca(OH)₂: total inorganic carbonated species in the carbonated water ratio is in the range of 8:10 to 9:10 mol/mol.

According to some embodiments, the application of the present method using these parameters results in dissolved inorganic carbon removal in the range of 80% to 90%. According to some embodiments, this rate of dissolved inorganic carbon removal is achieved by flowing the water within the fluidized bed reactor for a residence time in the range of 1 minute to 20 minutes, 1 minute to 10 minutes or 1 minute to 5 minutes.

According to some embodiments, the particle size of the seeds of CaCO₃ is in the range of 0.109-0.122 millimeters, the particle size of the precipitated CaCO₃ pellets is in the range of 0.291-0.338 millimeters, the first superficial velocity is in the range of 40 to 50 meters per hour, the fluidized grains height in the range of 1-1.6 meters and the Ca(OH)₂: total inorganic carbonated species in the carbonated water ratio is in the range of 5:10 to 8:10 mol/mol.

According to some embodiments, the application of the present method using these parameters results in dissolved inorganic carbon removal in the range of 50% to 80%. According to some embodiments, this rate of dissolved inorganic carbon removal is achieved by flowing the water within the fluidized bed reactor for a residence time in the range of 1 minute to 20 minutes, 1 minute to 10 minutes or 1 minute to 5 minutes.

According to some embodiments, the particle size of the seeds of CaCO₃ is in the range of 0.122-0.133 millimeters, the particle size of the precipitated CaCO₃ pellets is in the range of 0.338-0.381 millimeters, the first superficial velocity is in the range of 50 to 60 meters per hour, the fluidized grains height in the range of 5.2-7.6 meters and Ca(OH)₂: total inorganic carbonated species in the carbonated water ratio is in the range of 9:10 to 10:10 mol/mol.

According to some embodiments, the application of the present method using these parameters results in dissolved inorganic carbon removal in the range of 90% to 100%. According to some embodiments, this rate of dissolved inorganic carbon removal is achieved by flowing the water within the fluidized bed reactor for a residence time in the range of 1 minute to 20 minutes, 1 minute to 10 minutes or 1 minute to 5 minutes.

According to some embodiments, the particle size of the seeds of CaCO₃ is in the range of 0.122-0.133 millimeters, the particle size of the precipitated CaCO₃ pellets is in the range of 0.338-0.381 millimeters, the first superficial velocity is in the range of 50 to 60 meters per hour, the fluidized grains height in the range of 2.8-4.1 meters and the Ca(OH)₂: total inorganic carbonated species in the carbonated water ratio is in the range of 8:10 to 9:10 mol/mol. According to some embodiments, the application of the present method using these parameters results in dissolved inorganic carbon removal in the range of 80% to 90%. According to some embodiments, this rate of dissolved inorganic carbon removal is achieved by flowing the water within the fluidized bed reactor for a residence time in the range of 1 minute to 20 minutes, 1 minute to 10 minutes or 1 minute to 5 minutes.

According to some embodiments, the particle size of the seeds of CaCO₃ is in the range of 0.122-0.133 millimeters, the particle size of the precipitated CaCO₃ pellets is in the range of 0.338-0.381 millimeters, the first superficial velocity is in the range of 50 to 60 meters per hour, the fluidized grains height in the range of 1.5-2.2 meters and the Ca(OH)₂: total inorganic carbonated species in the carbonated water ratio is in the range of 5:10 to 8:10 mol/mol. According to some embodiments, the application of the present method using these parameters results in dissolved inorganic carbon removal in the range of 50% to 80%. According to some embodiments, this rate of dissolved inorganic carbon removal is achieved by flowing the water within the fluidized bed reactor for a residence time in the range of 1 minute to 20 minutes, 1 minute to 10 minutes or 1 minute to 5 minutes.

According to some embodiments, the particle size of the seeds of CaCO₃ is in the range of 0.133-0.144 millimeters, the particle size of the precipitated CaCO₃ pellets is in the range of 0.381-0.423 millimeters, the first superficial velocity is in the range of 60 to 70 meters per hour, the fluidized grains height in the range of 7.2-9.9 meters and the Ca(OH)₂: total inorganic carbonated species in the carbonated water ratio is in the range of 9:10 to 10:10 mol/mol. According to some embodiments, the application of the present method using these parameters results in dissolved inorganic carbon removal in the range of 90% to 100%. According to some embodiments, this rate of dissolved inorganic carbon removal is achieved by flowing the water within the fluidized bed reactor for a residence time in the range of 1 minute to 20 minutes, 1 minute to 10 minutes or 1 minute to 5 minutes.

According to some embodiments, the particle size of the seeds of CaCO₃ is in the range of 0.133-0.144 millimeters, the particle size of the precipitated CaCO₃ pellets is in the range of 0.381-0.423 millimeters, the first superficial velocity is in the range of 60 to 70 meters per hour, the fluidized grains height in the range of 3.8-5.3 meters and the Ca(OH)₂: total inorganic carbonated species in the carbonated water ratio is in the range of 8:10 to 9:10 mol/mol. According to some embodiments, the application of the present method using these parameters results in dissolved inorganic carbon removal in the range of 80% to 90%. According to some embodiments, this rate of dissolved inorganic carbon removal is achieved by flowing the water within the fluidized bed reactor for a residence time in the range of 1 minute to 20 minutes, 1 minute to 10 minutes or 1 minute to 5 minutes.

According to some embodiments, the particle size of the seeds of CaCO₃ is in the range of 0.133-0.144 millimeters, the particle size of the precipitated CaCO₃ pellets is in the range of 0.381-0.423 millimeters, the first superficial velocity is in the range of 60 to 70 meters per hour, the fluidized grains height in the range of 2.1-2.8 meters and the Ca(OH)₂: total inorganic carbonated species in the carbonated water ratio is in the range of 5:10 to 8:10 mol/mol. According to some embodiments, the application of the present method using these parameters results in dissolved inorganic carbon removal in the range of 50% to 80%. According to some embodiments, this rate of dissolved inorganic carbon removal is achieved by flowing the water within the fluidized bed reactor for a residence time in the range of 1 minute to 20 minutes, 1 minute to 10 minutes or 1 minute to 5 minutes.

According to some embodiments, the particle size of the seeds of CaCO₃ is in the range of 0.144-0.154 millimeters, the particle size of the precipitated CaCO₃ pellets is in the range of 0.423-0.462 millimeters, the first superficial velocity is in the range of 70 to 80 meters per hour, the fluidized grains height in the range of 9.3-12.4 meters and the Ca(OH)₂: total inorganic carbonated species in the carbonated water ratio is in the range of 9:10 to 10:10 mol/mol. According to some embodiments, the application of the present method using these parameters results in dissolved inorganic carbon removal in the range of 90% to 100%. According to some embodiments, this rate of dissolved inorganic carbon removal is achieved by flowing the water within the fluidized bed reactor for a residence time in the range of 1 minute to 20 minutes, 1 minute to 10 minutes or 1 minute to 5 minutes.

According to some embodiments, the particle size of the seeds of CaCO₃ is in the range of 0.144-0.154 millimeters, the particle size of the precipitated CaCO₃ pellets is in the range of 0.423-0.462 millimeters, the first superficial velocity is in the range of 70 to 80 meters per hour, the fluidized grains height in the range of 4.9-6.6 meters and the Ca(OH)₂: total inorganic carbonated species in the carbonated water ratio is in the range of 8:10 to 9:10 mol/mol. According to some embodiments, the application of the present method using these parameters results in dissolved inorganic carbon removal in the range of 80% to 90%. According to some embodiments, this rate of dissolved inorganic carbon removal is achieved by flowing the water within the fluidized bed reactor for a residence time in the range of 1 minute to 20 minutes, 1 minute to 10 minutes or 1 minute to 5 minutes.

According to some embodiments, the particle size of the seeds of CaCO₃ is in the range of 0.144-0.154 millimeters, the particle size of the precipitated CaCO₃ pellets is in the range of 0.423-0.462 millimeters, the first superficial velocity is in the range of 70 to 80 meters per hour, the fluidized grains height in the range of 2.6-3.5 meters and the Ca(OH)₂: total inorganic carbonated species in the carbonated water ratio is in the range of 5:10 to 8:10 mol/mol. According to some embodiments, the application of the present method using these parameters results in dissolved inorganic carbon removal in the range of 50% to 80%. According to some embodiments, this rate of dissolved inorganic carbon removal is achieved by flowing the water within the fluidized bed reactor for a residence time in the range of 1 minute to 20 minutes, 1 minute to 10 minutes or 1 minute to 5 minutes.

According to some embodiments, further detailed herein, step (VI) of the present method includes dissociating the scavenged carbon species to form carbon dioxide and a decarbonated solid material.

According to some embodiments, step (VI) includes thermally, electrically or chemically dissociating the scavenged carbon species. Each possibility represents a separate embodiment of the invention. According to some embodiments, step (VI) includes thermally dissociating the scavenged carbon species. According to some embodiments, step (VI) includes calcining the scavenged carbon species.

According to some embodiments, the carbon dioxide formed in step (VI) is CO₂ gas. According to some embodiments, the carbon dioxide is released as a gas.

According to some embodiments, dissociating the scavenged carbon species comprises heating the scavenged carbon species to induce thermal decomposition into carbon dioxide and a decarbonated solid material.

As detailed above, one particular scavenged carbon species is CaCO₃, according to some embodiments. When inducing thermal dissociation to CaCO₃ it is dissociated into CO₂ and CaO according the reaction scheme below:

CaCO₃→CaO+CO₂.

Thus, according to some embodiments, step (VI) entails performing the reaction in the above paragraph.

According to some embodiments, the decarbonated solid material comprises CaO.

According to some embodiments, the decarbonated solid material is CaO.

According to some embodiments, the CO₂ formed in step (VI) is in the gas form, and step (VII) comprises isolating the CO₂ gas from the mixture of step (VI) and storing the CO₂ gas. According to some embodiments, the CO₂ formed in step (VI) is in the gas form, and step (VII) comprises isolating the CO₂ gas from the mixture of step (VI) and storing the CO₂ gas in a dedicated container (not shown) or designated storage site (such as underground geological formations, not shown). Suitable containers for CO₂ storage, include, but not limited to gas cylinders. Other storage methods include, but are not limited to, condensing the CO₂, (e.g., liquidating it) and storing it as a condensed state within depleted oil or gas fields or saline aquifers.

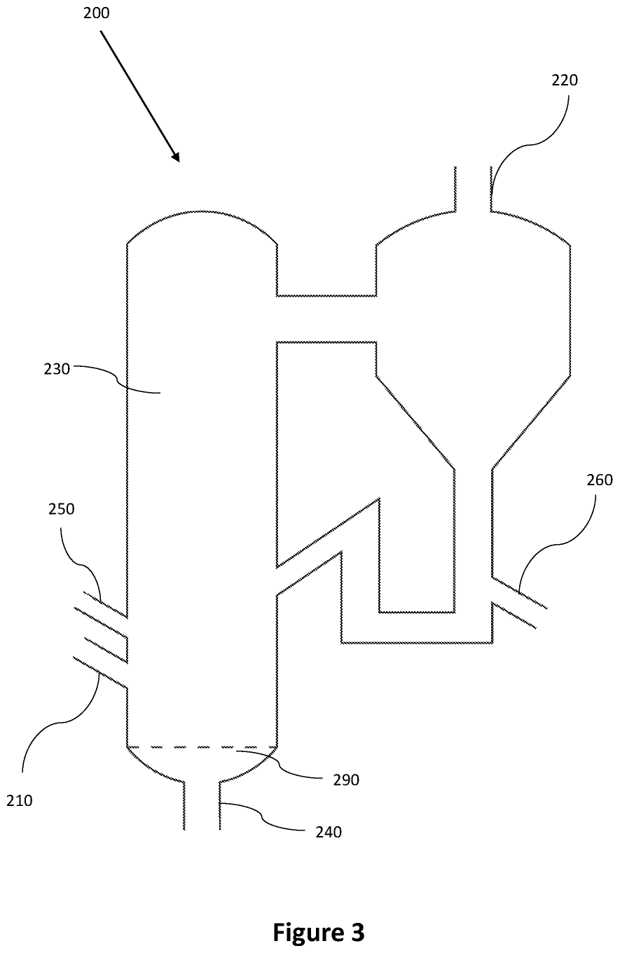

Reference is now made to FIG. 3.

According to some embodiments, the carbon removal system 10 described herein comprises a calciner 200. According to some embodiments, step (VI) comprises dissociating the scavenged carbon species in the calciner 200.

The term “calciner” generally refers to a steel cylinder that rotates inside a heated furnace and performs indirect high-temperature processing (550-1150° C.) within a controlled atmosphere.

According to some embodiments, the calciner 200 is a circulating fluidized bed calciner.

According to some embodiments, the calciner 200 comprises a solid inlet pipe 210. According to some embodiments, the calciner 200 comprises a gas outlet pipe 220. calciner 200 comprises a heating chamber 230.

According to some embodiments, the solid inlet pipe 210 is in fluid communication with the solid outlet pipe 150 of the pellet reactor 100.

According to some embodiments, the solid inlet pipe 210 is in fluid communication with the heating chamber 230.

According to some embodiments, step (VI) comprises inserting the scavenged carbon species isolated in step (IV) through the solid inlet pipe 210 into the heating chamber 230.

According to some embodiments, the solid inlet pipe 210 comprises a valve (not shown) configured to monitor the solid flow into the heating chamber 230. According to some embodiments, the valve is configured to allow unidirectional flow of solids into the heating chamber 230.

According to some embodiments, the gas outlet pipe 220 is in fluid communication with the heating chamber 230. According to some embodiments, the gas outlet pipe 220 is in fluid communication with the dedicated CO₂ storage container (not shown).

According to some embodiments, step (VI) comprises further elevating the temperature within the heating chamber 230. According to some embodiments, the temperature elevation entails dissociating the scavenged carbon species to form carbon dioxide gas and the decarbonated solid material.

According to some embodiments, step (VI) further comprises evacuating the carbon dioxide gas through the gas outlet pipe 220.

According to some embodiments, the gas outlet pipe 220 comprises a valve (not shown) configured to monitor the gas flow out of the heating chamber 230. According to some embodiments, the valve is configured to allow unidirectional flow of gas away from the heating chamber 230.

As detailed below, one option of dissociating the water-insoluble scavenged carbon species in the heating chamber 230 into carbon dioxide and a decarbonated solid material, involves combustion, according to some embodiments. As either oxygen gas or air may be used to promote the combustion, other gasses (e.g., water vapor and nitrogen gas) may be present in the heating chamber 230, and these may also be evacuated together with the CO₂ gas.

Thus, according to some embodiments, step (VI) further comprises evacuating water vapor, nitrogen gas or both from the heating chamber 230, through the gas outlet pipe 220. Each possibility represents a separate embodiment of the invention.

According to some embodiments, the heating chamber 230 is a combustion chamber. According to some embodiments, the heating chamber 230 comprises a furnace.

According to some embodiments, the calciner further comprises an oxidizing gas inlet pipe 240. The oxidizing gas inlet pipe 240 is also referred as “first gas inlet pipe” in various sections of the present disclosure. According to some embodiments, the calciner further comprises reducing fluid pipe 250. The reducing fluid pipe 250 is also referred as “second gas inlet pipe” in various sections of the present disclosure.

According to some embodiments, the oxidizing gas inlet pipe 240 is in fluid communication with the heating chamber 230. According to some embodiments, the reducing fluid pipe 250 is in fluid communication with the heating chamber 230.

According to some embodiments, the oxidizing gas inlet pipe 240 comprises a valve (not shown) configured to monitor the gas flow into the heating chamber 230. According to some embodiments, the valve is configured to allow unidirectional flow of oxidizing gas into the heating chamber 230.

According to some embodiments, the reducing fluid pipe 250 comprises a valve (not shown) configured to monitor the fluid flow into the heating chamber 230. According to some embodiments, the valve is configured to allow unidirectional flow of fluid into the heating chamber 230.

As detailed above, according to some embodiments, one product of the reaction of step (III) is water-insoluble scavenged carbon species (e.g., CaCO₃), which may be evacuated through the solid outlet pipe 150 of the pellet reactor 100. As, according to some embodiments, the solid outlet pipe 150 of the pellet reactor 100 is in fluid communication with the solid inlet pipe 210 of the calciner 200, the formed scavenged carbon species pellets, if not crushed and reused as seeds, may be fed to the calciner 200 through the solid inlet pipe 210. The calciner 200, according to some embodiments, is a circulating fluidized bed reactor. It includes a heating chamber 230, in which the scavenged carbon species pellets are fluidized by a mix of reducing fluid(s) and air or oxygen, according to some embodiments. Reducing fluids include, but are not limited to, natural gas, oil and/or hydrogen gas. The gas mixture is combusted and the produced heat is used to thermally decompose the calcium carbonate pellets according to the following chemical reaction:

CaCO₃(s)→CaO(s)+CO₂(g)

According to some embodiments, following the thermal decomposition of the calcium carbonate pellets, the quicklime (CaO) solids are conveniently separated from the gas phase which contains CO₂ from the decomposition of the CaCO₃ as well as CO₂ that originates from the combustion of the reducing fluid, optionally with water vapors and nitrogen (if the reducing fluid was mixed with air rather than pure oxygen). Heat from the quicklime and the outgoing exhaust gas may be recovered using heat exchangers (not shown), according to some embodiments. The gas phase is then evacuated through the gas outlet pipe 220, according to some embodiments. Optionally, the gas it dried and sequestered in geologic formation in land or sea thereafter, according to some embodiments. The solid CaO formed in the dissociation reaction may then be evacuated and further processed as detailed below (when discussion evacuation through the solid outlet 260).

According to some embodiments, elevating the temperature within the heating chamber in step (VI) comprises inserting a combustible gas through the reducing fluid pipe 250; inserting oxygen gas through the oxidizing gas inlet pipe 240, and combusting the gas mixture in the combustion chamber 230 to elevate the temperature therein.

According to some embodiments, the oxygen gas inserted into the combustion chamber 230 through the oxidizing gas inlet pipe 240 is provided therein as air.

According to some embodiments, the method further comprising absorbing the heat produced in the combustion. Specifically, in order to maintain an environmentally friendly process the CO₂ formed by the combustion is also stored and the resulting heat is used for power generation, according to some embodiments. According to some embodiments, absorbing the heat produced in the combustion is performed using a heat exchanger. Therefore, according to some embodiments, the carbon removal system 10 further comprises a heat exchanger configured to draw energy produced in the reaction within the heating chamber 230.

Also, as detailed with respect to the distributor plate 190 of the pellet reactor 100, according to some embodiments, the calciner 200 may also include a distributor plate 290. According to some embodiments, the calciner 200 comprises a distributor plate 290 configured to transfer a pressurized stream of the oxygen gas from the oxidizing gas inlet pipe 240 to the heating chamber 230.

Furthermore, as elaborated above, a product of the reaction of step (VI) is a decarbonated solid material, which, according to some embodiments, may be CaO. In order to complete an environmentally friendly process, which avoids material waste, the decarbonated solid material may be used to regenerate carbon dioxide scavenger molecules to be used in steps (II)-(III), according to some embodiments. For this, the decarbonated solid material should be evacuated from the calciner 200, according to some embodiments.

According to some embodiments, the calciner 200 further comprises a solid outlet pipe 260. According to some embodiments, the solid outlet pipe 260 is in fluid communication with the heating chamber 230. According to some embodiments, (VI) further comprises evacuating the decarbonated solid material through the solid outlet pipe 260.

According to some embodiments, the solid outlet pipe 260 comprises a valve (not shown) configured to monitor the solid flow out of the heating chamber 230. According to some embodiments, the valve is configured to allow unidirectional flow of solids out of the heating chamber 230.

According to some embodiments, the method further comprises step (VIII) of processing the decarbonated solid material formed in step (VI) into a carbon dioxide scavenger. According to some embodiments, the method further comprises step (VIII) of processing the decarbonated solid material formed in step (VI) into a carbon dioxide scavenger and repeating steps (I)-(VII). According to some embodiments, step (II) comprises providing the carbon dioxide scavenger formed in step (VIII).

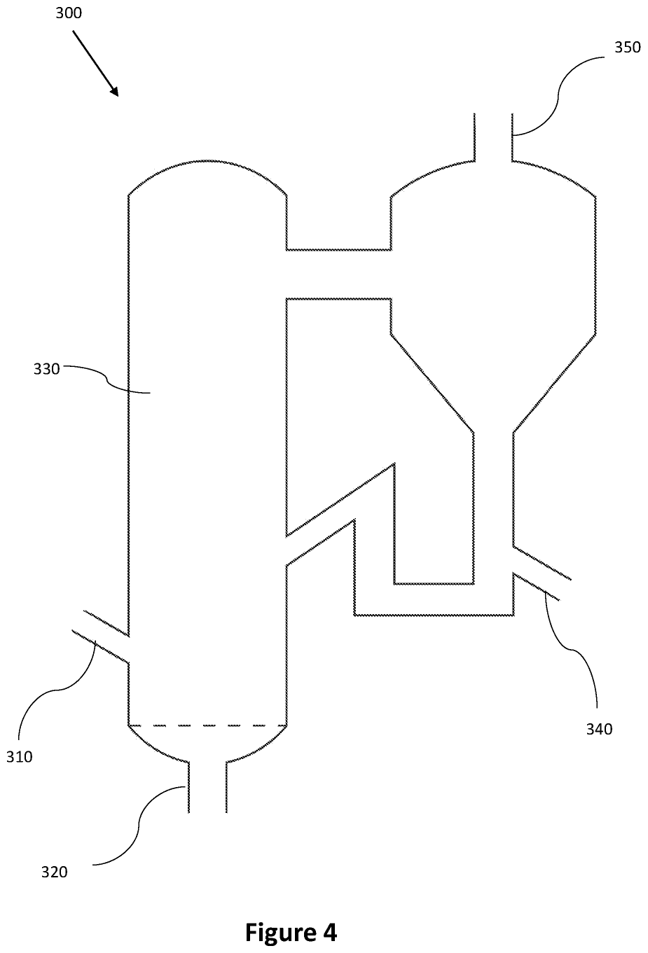

Reference is now made to FIG. 4.

According to some embodiments, the carbon removal system 10 comprises a slaker 300. According to some embodiments, the process further comprises step (VIII) of processing the decarbonated solid material formed in step (VI) into a carbon dioxide scavenger in the slaker 300.

According to some embodiments, the slaker 300 is a circulating fluidized bed steam slaker.

According to some embodiments, the slaker 300 comprises a solid inlet pipe 310.

According to some embodiments, the slaker 300 comprises a steam inlet pipe 320.

According to some embodiments, the slaker 300 comprises a slaking chamber 330.

According to some embodiments, the slaker 300 comprises a solid outlet pipe 340.

According to some embodiments, the solid inlet pipe 310 of the slaker 300 is in fluid communication with the solid outlet 260 of the calciner 200. Specifically, as specified above, the decarbonated solid material produced in the calciner 200 is transferred for further processing in the slaker 300.

According to some embodiments, the solid inlet pipe 310 is in fluid communication with the slaking chamber 330.

According to some embodiments, each of the pipes 310, 320 and 340 is in fluid communication with the slaking chamber 330.

According to some embodiments, step (VIII) comprises inserting the decarbonated solid material formed in step (VI) into the slaking chamber 330 through the solid inlet pipe 310.

According to some embodiments, the solid inlet pipe 310 comprises a valve (not shown) configured to monitor the solid flow into the slaking chamber 330. According to some embodiments, the valve is configured to allow unidirectional flow of solids into the slaking chamber 330.

According to some embodiments, step (VIII) further comprises inserting steam into the slaking chamber through the steam inlet pipe 320.

According to some embodiments, step (VIII) further comprises reacting the steam with the decarbonated solid material in the slaking chamber 330 to form a carbon dioxide scavenger.

According to some embodiments, the steam inlet pipe 320 comprises a valve (not shown) configured to monitor steam flow into the slaking chamber 330. According to some embodiments, the valve is configured to allow unidirectional flow of steam into the slaking chamber 330.

According to some embodiments, step (VIII) further comprises reacting the steam with the CaO in the slaking chamber 330 to form Ca(OH)₂. The reaction scheme is shown below:

CaO+H₂O→Ca(OH)₂

According to some embodiments, step (VIII) further comprises evacuating the carbon dioxide scavenger through the outlet pipe 340.

According to some embodiments, the outlet pipe 340 comprises a valve (not shown) configured to monitor flow out of the slaking chamber 330. According to some embodiments, the valve is configured to allow unidirectional flow out of the slaking chamber 330.

According to some embodiments, the slaker 300 further comprises a steam outlet pipe 350. According to some embodiments, step (VIII) further comprises evacuating excess steam from the slaking chamber 330 through the steam outlet pipe 350.

According to some embodiments, the steam outlet pipe 350 is in fluid communication with the slaking chamber 330.

According to some embodiments, the steam outlet pipe 350 comprises a valve (not shown) configured to monitor flow of steam out of the slaking chamber 330. According to some embodiments, the valve is configured to allow unidirectional steam flow out of the slaking chamber 330.

According to some embodiments, there is provided a carbon removal system 10 as disclosed herein.

According to some embodiments, there is provided a carbon removal system comprising: a fluidized bed pellet reactor comprising: a first fluid inlet pipe, a solid inlet pipe, a fluid outlet pipe, a solid outlet pipe, and an enclosed reaction chamber, which comprises a top end and a bottom end, wherein each of the solid inlet pipe and the fluid outlet pipe is connected to the reaction chamber in the vicinity of its top end, and each of the solid outlet pipe and the first fluid inlet pipe is connected to the reaction chamber in the vicinity of its bottom end; a circulating fluidized bed calciner comprising: a solid inlet pipe, a gas outlet pipe, a first gas inlet pipe, a second gas inlet pipe, a solid outlet pipe, and a combustion chamber, wherein each of the pipes is in fluid communication with the combustion chamber; and a circulating fluidized bed steam slaker comprising: a solid inlet pipe, a steam inlet pipe, a solid outlet pipe, a steam outlet pipe and a slaking chamber, wherein each of the pipes is in fluid communication with the slaking chamber; wherein the solid outlet pipe of the pellet reactor is in fluid communication with the solid inlet pipe of the calciner, wherein the solid outlet pipe of the calciner is in fluid communication with the solid inlet pipe of the slaker, and wherein the solid outlet pipe of the slaker is in fluid communication with the liquid inlet pipe of the pellet reactor.

According to some embodiments, there is provided a carbon removal system comprising: a fluidized bed pellet reactor comprising: a first fluid inlet pipe, a second fluid inlet pipe, a solid inlet pipe, a fluid outlet pipe, a solid outlet pipe, and an enclosed reaction chamber, which comprises a top end and a bottom end, wherein each of the solid inlet pipe and the fluid outlet pipe is connected to the reaction chamber in the vicinity of its top end, and each of the solid outlet pipe, first fluid inlet pipe and the second fluid inlet pipe is connected to the reaction chamber in the vicinity of its bottom end; a circulating fluidized bed calciner comprising: a solid inlet pipe, a gas outlet pipe, a first gas inlet pipe, a second gas inlet pipe, a solid outlet pipe, and a combustion chamber, wherein each of the pipes is in fluid communication with the combustion chamber; and a circulating fluidized bed steam slaker comprising: a solid inlet pipe, a steam inlet pipe, a solid outlet pipe, a steam outlet pipe and a slaking chamber, wherein each of the pipes is in fluid communication with the slaking chamber; wherein the solid outlet pipe of the pellet reactor is in fluid communication with the solid inlet pipe of the calciner, wherein the solid outlet pipe of the calciner is in fluid communication with the solid inlet pipe of the slaker, and wherein the solid outlet pipe of the slaker is in fluid communication with the second liquid inlet pipe of the pellet reactor.

### Examples

### Example 1—Lab Scale Carbon Dioxide Removal and Capture of Seawater

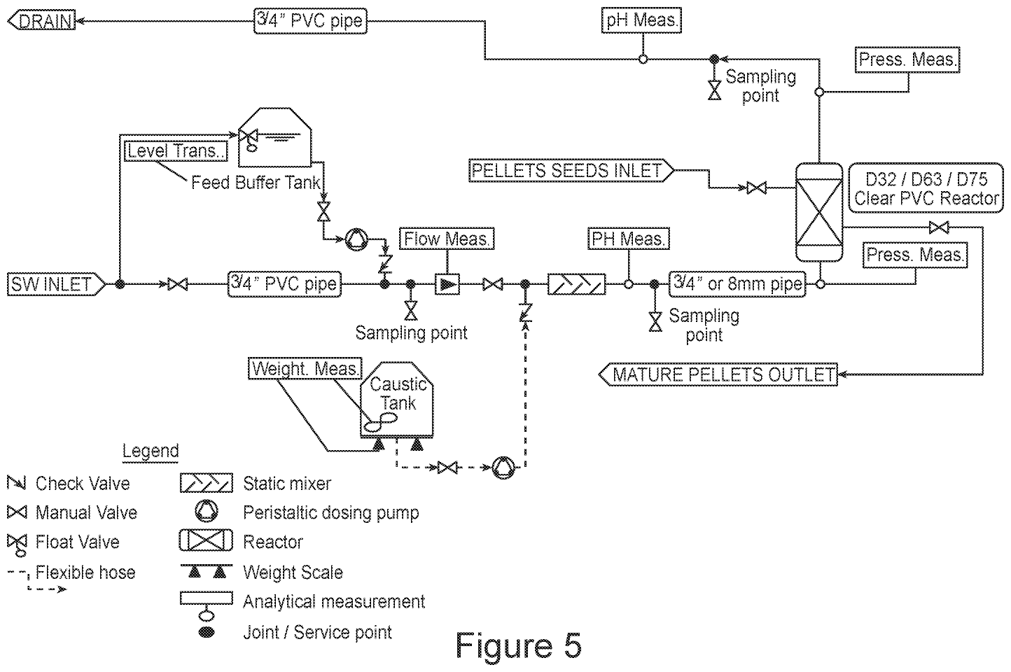

An experimental setup was constructed as described in FIG. 5. The setup contains a feed of seawater that fills a buffer tank, which eliminates pressure fluctuations originating from the seawater pumping infrastructure. In the buffer tank, two Aqua One heating rods (200W and 300W) elevate the temperature of the seawater to 25° C. From the buffer tank, seawater was dosed by a peristaltic pump (DULCO flex Control 7 bar 30 Liter) into the inlet pipe that connects to a fluidized bed reactor with an internal diameter of 28 millimeters. At the same time, another peristaltic pump doses NaOH solution from a pre-prepared solution tank into the same inlet pipe that connects to the fluidized bed reactor. The mixture of the seawater and NaOH passes through a 150-micron nylon mesh that serves as a distribution plate for a mass of CaCO₃ grains obtained from a limestone quarry near Haifa, Israel, and sieved using two sieves of meshes 212 and 300 micrometers to achieve a narrow size distribution of grains centered around d̅ₛ=(212+300)/2=256 μm. Following the pass through the fluidized bed reactor, the seawater/NaOH solution was disposed of through an effluent pipe. The inlet and effluent pipes are embedded each with pressure and pH transmitters (SML and Endrress & Hauser CPF81E-AA5NAD1 electrode+CM14 transmitter) to verify proper mixing of the NaOH and seawater, qualitatively identify CaCO₃ precipitation (which lowers pH because it promotes deprotonation of bicarbonate ions), and ensure that the distribution nylon mesh is not clogged by precipitated CaCO₃, which increases the pressure difference across the fluidized bed reactor above 0.4 bar and leads to an unbalanced fluidization. In addition, the inlet pipe contains a temperature transmitter (MUNSEN TH30 PT100 transmitter) which is used to measure the temperature and calculate relevant reaction constants. Also, the inlet and effluent pipes contain ports that allow drawing of water samples for a more accurate analysis. For each experiment, the following parameters were measured: height of the fluidized bed (fluidized grains height, measured with a meter); throughputs of the two pumps; the inline temperature of the inlet solution; turbidity of the inlet and outlet (using Thermo Eutech TN-100 Turbidimeter); conductivity of the inlet solution (using Thermo Eutech PC-450-PH/EC/TEMP), which was then converted to salinity based on a conversion factor of 0.7183 obtained from measurement of S=38 gr/kg salinity calibration sample with the conductivity meter; pH of the seawater, inlet, and effluent solutions (using Thermo Eutech PC-450-PH/EC/TEMP); and alkalinity of the seawater, inlet, and effluent solutions (using Gran titration). For each set of parameters, the described parameters were measured two times in time intervals of one hour. In experiments where the results of the two samples deviated by more than 5%, another sample point was took after an hour. If the deviation persisted (namely, the third point deviated by more than 5% from the other two), the experiment was considered as yielding non-repeatable results and conducted was again after equipment calibration. After completing an experiment with repeatable measurements, the results were averaged to reduce stochastic sampling errors. The results are presented below.

Specifically, the parameters required for the integration were calculated based on the experimental measurements and/or setting of the bed height, seawater feed throughput, seawater chemical characteristics, NaOH solution throughput, NaOH solution concentration, and temperature. The chemical characteristics of the seawater include its alkalinity (measured by Gran titration), DIC (calculated from alkalinity and pH), salinity (calculated from measured conductivity), and calcium concentration which was taken to be constant 0.01 mM based on literature [Daniel Milshteyn, Bruce Damer, Jeff Havig, and David Deamer. Amphiphilic compounds assemble into membranous vesicles in hydrothermal hot spring water but not in seawater. Life, 8 (2): 11, 2018].

A steady-state operation of the precipitation reactor was constructed as detailed above in order to determine the performance of a fluidized bed reactor for the precipitation of CaCO₃ from seawater. A mixture of Ca(OH)₂ and seawater is passed through a fluidized bed precipitation reactor to remove DIC, until the alkalinity of the mixture is equal to that of seawater, so that the effluent seawater can reabsorb the same amount of CO₂ from the atmosphere as was removed as CaCO₃. It was surprisingly found that the residence time required for the fluid inside the reactor is of the order of a few minutes for removal of more than 50% of the DIC. Advantageously, that is a more than two orders of magnitude improvements compared to conventional precipitation tanks.

### Example 2—Commercial Scale Carbon Dioxide Removal and Capture of Seawater

Following adjustment of the experiment of Example 1 by using Ca(OH)₂ instead of NaOH and moving to a larger scale, the parameters are used and the dissolved inorganic carbon removal percentage are shown in Table 1.

TABLE 1
Parameters and DIC removal reduction

| | | superficial | Fluidized | DIC | Ca(OH)₂ concentration |
|---|---|---|---|---|---|
| Seed size | Pellet size | velocity | bed height | removal | added as percentage of |
| (mm) | (mm) | (m/h) | (m) | % | the initial DIC |
| 0.077-0.094 | 0.183-0.240 | 20-30 | 1.1-2.4 | 90-100% | 90-100% |
| 0.077-0.094 | 0.183-0.240 | 20-30 | 0.6-1.3 | 80-90% | 80-90% |
| 0.077-0.094 | 0.183-0.240 | 20-30 | 0.3-0.7 | 50-80% | 50-80% |
| 0.094-0.109 | 0.240-0.291 | 30-40 | 2.2-3.9 | 90-100% | 90-100% |
| 0.094-0.109 | 0.240-0.291 | 30-40 | 1.2-2.1 | 80-90% | 80-90% |
| 0.094-0.109 | 0.240-0.291 | 30-40 | 0.6-1.1 | 50-80% | 50-80% |
| 0.109-0.122 | 0.291-0.338 | 40-50 | 3.6-5.6 | 90-100% | 90-100% |
| 0.109-0.122 | 0.291-0.338 | 40-50 | 1.9-3 | 80-90% | 80-90% |
| 0.109-0.122 | 0.291-0.338 | 40-50 | 1-1.6 | 50-80% | 50-80% |
| 0.122-0.133 | 0.338-0.381 | 50-60 | 5.2-7.6 | 90-100% | 90-100% |
| 0.122-0.133 | 0.338-0.381 | 50-60 | 2.8-4.1 | 80-90% | 80-90% |
| 0.122-0.133 | 0.338-0.381 | 50-60 | 1.5-2.2 | 50-80% | 50-80% |
| 0.133-0.144 | 0.381-0.423 | 60-70 | 7.2-9.9 | 90-100% | 90-100% |
| 0.133-0.144 | 0.381-0.423 | 60-70 | 3.8-5.3 | 80-90% | 80-90% |
| 0.133-0.144 | 0.381-0.423 | 60-70 | 2.1-2.8 | 50-80% | 50-80% |
| 0.144-0.154 | 0.423-0.462 | 70-80 | 9.3-12.4 | 90-100% | 90-100% |
| 0.144-0.154 | 0.423-0.462 | 70-80 | 4.9-6.6 | 80-90% | 80-90% |
| 0.144-0.154 | 0.423-0.462 | 70-80 | 2.6-3.5 | 50-80% | 50-80% |

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

1. A method for removing carbon dioxide (CO₂), the method comprising the step of:
(I) providing carbonated water from a natural or unnatural carbonated water source, wherein the carbonated water comprises an inorganic carbonated species selected from the group consisting of: CO₂, H₂CO₃, HCO₃⁻ and a combination thereof, at a first concentration, and wherein the carbonated water has pH of no more than 11 and an initial alkalinity;
(II) providing a carbon dioxide scavenger;
(III) contacting the carbonated water with the carbon dioxide scavenger to form a solid water-insoluble scavenged carbon species and decarbonated water;
(IV) isolating the scavenged carbon species from the decarbonated water, wherein the decarbonated water has final alkalinity, which is in the range of 75% to 125% of the initial alkalinity;
(V) transferring the decarbonated water to the natural or unnatural carbonated water source;
(VI) dissociating the scavenged carbon species to form carbon dioxide and a decarbonated solid material; and
(VII) capturing the carbon dioxide formed in step (VI).

2-4. (canceled)

5. The method according to claim 1, wherein the carbonated water comprises HCO₃⁻ and, CO₃⁻², wherein the carbonated water comprises at least 2 HCO₃⁻ ions per one CO₃⁻² ion.

6. (canceled)

7. The method according to claim 1, wherein the first concentration is at least 0.1 mM and wherein the carbonated water of step (I) has pH in the range of 7 to 8.5.

8. (canceled)

9. The method according to claim 1, wherein the salinity of the carbonated water of step (I) is in the range of 0.5 to 100 g/L.

10. The method according to claim 1, wherein the carbon dioxide scavenger is Ca(OH)₂.

11. (canceled)

12. The method according to claim 10, wherein the carbonated water comprises CO₃⁻², and wherein the contacting of carbonated water with the Ca(OH)₂ in step (III) entails carrying out either of the chemical reactions:
CO₂+Ca(OH)₂→CaCO₃+H₂O;
H₂CO₃+Ca(OH)₂→CaCO₃+2H₂O;
HCO₃⁻+Ca(OH)₂→CaCO₃+H₂O+OH⁻;
CO₃⁻²+Ca(OH)₂→CaCO₃+2OH⁻;
thereby producing CaCO₃ as the solid water-insoluble scavenged carbon species, and decarbonated water, whose alkalinity is substantially equal to the alkalinity of the carbonated water of step (I).

13-14. (canceled)

15. The method according to claim 1, wherein the solid water-insoluble scavenged carbon species is CaCO₃.

16. The method according to claim 15, wherein forming CaCO₃ in step (III) comprises inducing precipitation of the CaCO₃ from the water, through seeding seeds of CaCO₃ in the mixture of step (III).

17. The method according to claim 16, wherein the seeds of CaCO₃ have an average particle size in the range of 0.07 to 0.160 millimeters.

18. The method according to claim 16, wherein step (III) further comprises allowing maturation of pellets of precipitated CaCO₃, to a pellet size in the range of 0.15 to 0.5 millimeters, wherein the step (IV) comprises isolating the precipitated CaCO₃ pellets, matured to said pellet size.

19-23. (canceled)

24. The method according to claim 1, wherein the decarbonated solid material comprises CaO.

25. The method according to claim 1, further comprising step (VIII) of processing the decarbonated solid material formed in step (VI) into a carbon dioxide scavenger and repeating steps (I)-(VI), wherein step (II) comprises providing the carbon dioxide scavenger formed in step (VIII).

26. The method according to claim 1, wherein steps (I)-(IV) are devoid of air treatment.

27. The method according to claim 1, wherein the method further comprises providing a carbon removal system, wherein at least one of steps (I) to (VII) is carried out within the carbon removal system wherein the carbon removal system comprises a fluidized bed pellet reactor, wherein step (III) comprises contacting in the fluidized bed pellet reactor the carbonated water with the carbon dioxide scavenger to form a solid water-insoluble scavenged carbon species and decarbonated water.

28. The method according to claim 27, wherein the fluidized bed pellet reactor comprises a first fluid inlet pipe, a fluid outlet pipe and an enclosed reaction chamber, each of the fluid inlet pipe and the fluid outlet pipe is in fluid communication with the reaction chamber, wherein step (III) comprises inserting the carbonated water into the reaction chamber through the fluid inlet pipe, and wherein the contacting of the carbonated water with the carbon dioxide scavenger in step (III) is carried out within the reaction chamber.

29. The method according to claim 28, wherein the fluidized bed pellet reactor further comprises a second fluid inlet pipe, and step (III) comprises forming a composition of the carbon dioxide scavenger in water and inserting the formed composition into the reaction chamber through the second fluid inlet pipe
wherein step (III) further comprises evacuating the decarbonated water through the fluid outlet pipe
wherein the fluidized bed pellet reactor further comprises a semi-permeable filter, which is permeable to water and impermeable to solids above a predetermined diameter, and is positioned to separate between the reaction chamber and the fluid outlet pipe; wherein the evacuation of the decarbonated water of step (III) comprises filtering the decarbonated water from the scavenged carbon species by flowing the decarbonated water through the semi-permeable filter, and flowing the filtered decarbonated water through the fluid outlet pipe
wherein the semi-permeable filter has a cutoff is in the range of 0.07 to 0.16 millimeters.

30-35. (canceled)

36. The method according to claim 28, wherein the fluidized bed pellet reactor further comprises a solid inlet pipe, wherein step (III) further comprises inserting seeds of the scavenged carbon species into the reaction chamber through the solid inlet pipe.

37. The method according to claim 36, wherein step (III) further comprises fluidizing the seeds in the reaction chamber, wherein the enclosed reaction chamber comprises a top end and a bottom end, wherein the solid inlet pipe is connected to the reaction chamber in the vicinity of its top end.

38-39. (canceled)

40. The method according to claim 27, wherein the carbon dioxide scavenger is Ca(OH)₂, wherein the fluidized bed pellet reactor further comprises a solid inlet pipe, wherein step (III) further comprises inserting seeds of the CaCO₃ into the reaction chamber through the solid inlet pipe and fluidizing the seeds in the reaction chamber to a fluidized grains height, thereby inducing precipitation and maturation of CaCO₃ pellets, wherein the fluidized grains height is in the range of 0.6 meter to 12.4 meter.

41. (canceled)

42. The method according to claim 40, wherein step (III) comprises inserting the carbonated water into the reaction chamber through the fluid inlet pipe at a first superficial velocity; and
the particle size of the seeds of CaCO₃ is in the range of 0.077-0.094 millimeters, the particle size of the precipitated CaCO₃ pellets is in the range of 0.183-0.240 millimeters, the first superficial velocity is in the range of 20 to 30 meters per hour, the fluidized grains height in the range of 1.1-2.4 meters and the Ca(OH)₂: total inorganic carbonated species in the carbonated water ratio is in the range of 9:10 to 10:10 mol/mol; or
the particle size of the seeds of CaCO₃ is in the range of 0.077-0.094 millimeters, the particle size of the precipitated CaCO₃ pellets is in the range of 0.183-0.240 millimeters, the first superficial velocity is in the range of 20 to 30 meters per hour, the fluidized grains height in the range of 0.6-1.3 meters and the Ca(OH)₂: total inorganic carbonated species in the carbonated water ratio is in the range of 8:10 to 9:10 mol/mol; or
the particle size of the seeds of CaCO₃ is in the range of 0.077-0.094 millimeters, the particle size of the precipitated CaCO₃ pellets is in the range of 0.183-0.240 millimeters, the first superficial velocity is in the range of 20 to 30 meters per hour, the fluidized grains height in the range of 0.3-0.7 meters and the Ca(OH)₂: total inorganic carbonated species in the carbonated water ratio is in the range of 5:10 to 8:10 mol/mol; or
the particle size of the seeds of CaCO₃ is in the range of 0.094-0.109 millimeters, the particle size of the precipitated CaCO₃ pellets is in the range of 0.240-0.291 millimeters, the first superficial velocity is in the range of 30 to 40 meters per hour, the fluidized grains height in the range of 2.2-3.9 meters and the Ca(OH)₂: total inorganic carbonated species in the carbonated water ratio is in the range of 9:10 to 10:10 mol/mol; or
the particle size of the seeds of CaCO₃ is in the range of 0.094-0.109 millimeters, the particle size of the precipitated CaCO₃ pellets is in the range of 0.240-0.291 millimeters, the first superficial velocity is in the range of 30 to 40 meters per hour, the fluidized grains height in the range of 1.2-2.1 meters and the Ca(OH)₂: total inorganic carbonated species in the carbonated water ratio is in the range of 8:10 to 9:10 mol/mol; or
the particle size of the seeds of CaCO₃ is in the range of 0.094-0.109 millimeters, the particle size of the precipitated CaCO₃ pellets is in the range of 0.240-0.291 millimeters, the first superficial velocity is in the range of 30 to 40 meters per hour, the fluidized grains height in the range of 0.6-1.1 meters and the Ca(OH)₂: total inorganic carbonated species in the carbonated water ratio is in the range of 5:10 to 8:10 mol/mol; or
the particle size of the seeds of CaCO₃ is in the range of 0.109-0.122 millimeters, the particle size of the precipitated CaCO₃ pellets is in the range of 0.291-0.338 millimeters, the first superficial velocity is in the range of 40 to 50 meters per hour, the fluidized grains height in the range of 3.6-5.6 meters and the Ca(OH)₂: total inorganic carbonated species in the carbonated water ratio is in the range of 9:10 to 10:10 mol/mol; or
the particle size of the seeds of CaCO₃ is in the range of 0.109-0.122 millimeters, the particle size of the precipitated CaCO₃ pellets is in the range of 0.291-0.338 millimeters, the first superficial velocity is in the range of 40 to 50 meters per hour, the fluidized grains height in the range of 1.9-3 meters and the Ca(OH)₂: total inorganic carbonated species in the carbonated water ratio is in the range of 8:10 to 9:10 mol/mol; or
the particle size of the seeds of CaCO₃ is in the range of 0.109-0.122 millimeters, the particle size of the precipitated CaCO₃ pellets is in the range of 0.291-0.338 millimeters, the first superficial velocity is in the range of 40 to 50 meters per hour, the fluidized grains height in the range of 1-1.6 meters and the Ca(OH)₂: total inorganic carbonated species in the carbonated water ratio is in the range of 5:10 to 8:10 mol/mol; or
the particle size of the seeds of CaCO₃ is in the range of 0.122-0.133 millimeters, the particle size of the precipitated CaCO₃ pellets is in the range of 0.338-0.381 millimeters, the first superficial velocity is in the range of 50 to 60 meters per hour, the fluidized grains height in the range of 5.2-7.6 meters and the Ca(OH)₂: total inorganic carbonated species in the carbonated water ratio is in the range of 9:10 to 10:10 mol/mol; or
the particle size of the seeds of CaCO₃ is in the range of 0.122-0.133 millimeters, the particle size of the precipitated CaCO₃ pellets is in the range of 0.338-0.381 millimeters, the first superficial velocity is in the range of 50 to 60 meters per hour, the fluidized grains height in the range of 2.8-4.1 meters and the Ca(OH)₂: total inorganic carbonated species in the carbonated water ratio is in the range of 8:10 to 9:10 mol/mol; or
the particle size of the seeds of CaCO₃ is in the range of 0.122-0.133 millimeters, the particle size of the precipitated CaCO₃ pellets is in the range of 0.338-0.381 millimeters, the first superficial velocity is in the range of 50 to 60 meters per hour, the fluidized grains height in the range of 1.5-2.2 meters and the Ca(OH)₂: total inorganic carbonated species in the carbonated water ratio is in the range of 5:10 to 8:10 mol/mol; or
the particle size of the seeds of CaCO₃ is in the range of 0.133-0.144 millimeters, the particle size of the precipitated CaCO₃ pellets is in the range of 0.381-0.423 millimeters, the first superficial velocity is in the range of 60 to 70 meters per hour, the fluidized grains height in the range of 7.2-9.9 meters and the Ca(OH)₂: total inorganic carbonated species in the carbonated water ratio is in the range of 9:10 to 10:10 mol/mol; or
the particle size of the seeds of CaCO₃ is in the range of 0.133-0.144 millimeters, the particle size of the precipitated CaCO₃ pellets is in the range of 0.381-0.423 millimeters, the first superficial velocity is in the range of 60 to 70 meters per hour, the fluidized grains height in the range of 3.8-5.3 meters and the Ca(OH)₂: total inorganic carbonated species in the carbonated water ratio is in the range of 8:10 to 9:10 mol/mol; or
the particle size of the seeds of CaCO₃ is in the range of 0.133-0.144 millimeters, the particle size of the precipitated CaCO₃ pellets is in the range of 0.381-0.423 millimeters, the first superficial velocity is in the range of 60 to 70 meters per hour, the fluidized grains height in the range of 2.1-2.8 meters and the Ca(OH)₂: total inorganic carbonated species in the carbonated water ratio is in the range of 5:10 to 8:10 mol/mol; or
the particle size of the seeds of CaCO₃ is in the range of 0.144-0.154 millimeters, the particle size of the precipitated CaCO₃ pellets is in the range of 0.423-0.462 millimeters, the first superficial velocity is in the range of 70 to 80 meters per hour, the fluidized grains height in the range of 9.3-12.4 meters and the Ca(OH)₂: total inorganic carbonated species in the carbonated water ratio is in the range of 9:10 to 10:10 mol/mol; or
the particle size of the seeds of CaCO₃ is in the range of 0.144-0.154 millimeters, the particle size of the precipitated CaCO₃ pellets is in the range of 0.423-0.462 millimeters, the first superficial velocity is in the range of 70 to 80 meters per hour, the fluidized grains height in the range of 4.9-6.6 meters and the Ca(OH)₂: total inorganic carbonated species in the carbonated water ratio is in the range of 8:10 to 9:10 mol/mol; or
the particle size of the seeds of CaCO₃ is in the range of 0.144-0.154 millimeters, the particle size of the precipitated CaCO₃ pellets is in the range of 0.423-0.462 millimeters, the first superficial velocity is in the range of 70 to 80 meters per hour, the fluidized grains height in the range of 2.6-3.5 meters and the Ca(OH)₂: total inorganic carbonated species in the carbonated water ratio is in the range of 5:10 to 8:10 mol/mol.
